(19) United States
(12) Patent Application Publication
(10) Pub. No.: US 2026/0342701 A1
(43) Pub. Date: Oct. 29, 2026

(54) Inter-Node Coordination of Competing RVQOE Configurations in MR-DC

(71) Applicant: Telefonaktiebolaget LM Ericsson (publ), Stockholm (SE)

(72) Inventors: Filip Barac, Huddinge (SE); Luca Lunardi, Genova (IT); Johan Rune, Lidingö (SE); Cecilia Eklöf, Täby (SE); Agne Ciuciulkaite, Uppsala (SE)

(21) Appl. No.: 19/115,414

(22) PCT Filed: Aug. 15, 2023
(86) PCT No.: PCT/SE2023/050823

§ 371 Date: Mar. 26, 2025

Related U.S. Application Data
(60) Provisional application No. 63/410,386, filed on Sep. 27, 2022.

(51) Int. Cl. H04L 43/0817; H04W 36/00

(52) U.S. Cl. CPC H04L 43/0817; H04W 36/0069

(57) ABSTRACT

Methods and apparatuses for facilitating Radio Access Network-Visible Quality of Experience (RVQoE) measurements in Next Generation Radio Access Networks (NG-RAN) networks. A method performed by a user equipment (UE) comprises receiving a first message comprising a first RV-QoE configuration of a first network node. The method further comprises receiving a second message comprising a second RV-QoE configuration of a second network node, determining whether the first network node or the second network node is delivering data for a session, and using the RV-QoE configuration of the determined network node to make RV-QoE measurements.

### TECHNICAL FIELD

The present disclosure relates to Next Generation Radio Access Networks (NG-RAN), and in particular to methods and apparatuses for making Radio Access Network-Visible Quality of Experience (RV-QoE) measurements.

### BACKGROUND

FIG. 1 depicts a NG-RAN Overall Architecture as defined in 3GPP TS 38.401 V17.2.0, available at https://portal.3gpp.org/desktopmodules/Specifications/Specification Details.aspx?specificationId=3219 as of 26 Jul. 2023.

The Next Generation Radio Access Network (NG-RAN) comprises a set of gNBs connected to the 5GC (Fifth Generation Core Network) through the NG interface.

NOTE: As specified in 3GPP TS 38.300 V17.2.0, available at https://portal.3gpp.org/desktopmodules/Specifications/SpecificationDetails.aspx?specific ationId=3191 as of 26 Jul. 2023, NG-RAN could also comprise of a set of ng-eNBs, an ng-eNB may comprise ng-eNB-CU (ng-eNB Central Units) and one or more ng-eNB-DU(s) (ng-eNB Distributed Unit(s)). An en-gNB is a gNB acting as a secondary node in an EN-DC scenario (e.g. in a Dual Connectivity (DC) scenario with an eNB as the master node and a gNB as the secondary node). An ng-eNB-CU and an ng-eNB-DU is connected via W1 interface. The general principle described in this section also applies to ng-eNB and W1 interface, if not explicitly specified otherwise.

A gNB can support Frequency Division Duplex (FDD) mode, Time Division

Duplex (TDD) mode or dual mode operation.

gNBs can be interconnected through the Xn interface.

A gNB may comprise a gNB-CU and one or more gNB-DU(s). A gNB-CU and a gNB-DU is connected via F1 interface.

One gNB-DU is connected to only one gNB-CU.

NOTE: In case of network sharing with multiple cell ID broadcast, each Cell Identity associated with a subset of Public Land Mobile Networks (PLMNs) corresponds to a gNB-DU and the gNB-CU it is connected to, e.g. the corresponding gNB-DUs share the same physical layer cell resources.

NOTE: For resiliency, a gNB-DU may be connected to multiple gNB-CUs by appropriate implementation.

NG, Xn and F1 are logical interfaces.

For NG-RAN, the NG and Xn-C interfaces for a gNB comprising a gNB-CU and gNB-DUs, terminate in the gNB-CU. For EN-DC, the S1-U and X2-C interfaces for a gNB comprising a gNB-CU and gNB-DUs, terminate in the gNB-CU. The gNB-CU and connected gNB-DUs are only visible to other gNBs and the 5GC as a gNB.

The node hosting user plane part of NR PDCP (e.g. gNB-CU, gNB-CU-UP, and for EN-DC, MeNB or SgNB depending on the bearer split) performs user inactivity monitoring and further informs its inactivity or (re) activation to the node having C-plane connection towards the core network (e.g. over E1, X2). The node hosting NR RLC (e.g. gNB-DU) may perform user inactivity monitoring and further inform its inactivity or (re) activation to the node hosting control plane, e.g. gNB-CU or gNB-CU-CP.

UL PDCP configuration (i.e. how the UE uses the UL at the assisting node) is indicated via X2-C(for EN-DC), Xn-C(for NG-RAN) and F1-C. Radio Link Outage/Resume for DL and/or UL is indicated via X2-U (for EN-DC), Xn-U (for NG-RAN) and F1-U.

The NG-RAN is layered into a Radio Network Layer (RNL) and a Transport Network Layer (TNL).

The NG-RAN architecture, i.e. the NG-RAN logical nodes and interfaces between them, is defined as part of the RNL.

For each NG-RAN interface (NG, Xn, F1) the related TNL protocol and the functionality are specified. The TNL provides services for user plane transport, signalling transport.

In NG-Flex configuration, each NG-RAN node is connected to all AMFs of AMF Sets within an AMF Region supporting at least one slice also supported by the NG-RAN node. The AMF Set and the AMF Region are defined in 3GPP TS 23.501 V17.6.0, available at https://portal.3gpp.org/desktopmodules/Specifications/SpecificationDetails.aspx?specific ationId=3144 as of 26 Jul. 2023.

If security protection for control plane and user plane data on TNL of NG-RAN interfaces is to be supported, NDS/IP 3GPP TS 33.501 V17.6.0, available at https://portal.3gpp.org/desktopmodules/Specifications/SpecificationDetails.aspx?specificationId=3169 as of 26 Jul. 2023 can be applied.

Overall architecture for separation of gNB-CU-CP and gNB-CU-UP

The overall architecture for separation of gNB-CU-CP and gNB-CU-UP is depicted in FIG. 1 and specified in 3GPP TS 37.483 V17.2.0, available at https://portal.3gpp.org/desktopmodules/Specifications/SpecificationDetails.aspx?specific ationId=3957 as of 26 Jul. 2023.

FIG. 1 depicts an overall architecture for separation of gNB-CU-CP and gNB-CU-UP.

A gNB may comprise a gNB-CU-CP, multiple gNB-CU-UPs and multiple gNB-DUs;

The gNB-CU-CP is connected to the gNB-DU through the F1-C interface;

The gNB-CU-UP is connected to the gNB-DU through the F1-U interface;

The gNB-CU-UP is connected to the gNB-CU-CP through the E1 interface;

One gNB-DU is connected to only one gNB-CU-CP;

One gNB-CU-UP is connected to only one gNB-CU-CP;

NOTE 1: For resiliency, a gNB-DU and/or a gNB-CU-UP may be connected to multiple gNB-CU-CPs by appropriate implementation.

One gNB-DU can be connected to multiple gNB-CU-UPs under the control of the same gNB-CU-CP;

One gNB-CU-UP can be connected to multiple DUs under the control of the same gNB-CU-CP;

NOTE 2: The connectivity between a gNB-CU-UP and a gNB-DU is established by the gNB-CU-CP using Bearer Context Management functions.

NOTE 3: The gNB-CU-CP selects the appropriate gNB-CU-UP(s) for the requested services for the UE. In case of multiple CU-UPs they belong to same security domain as defined in TS 33.210 V17.1.0, available at https://portal.3gpp.org/desktopmodules/Specifications/SpecificationDetails.aspx?specific ationId=2279 as of 26 Jul. 2023.

NOTE 4: Data forwarding between gNB-CU-UPs during intra-gNB-CU-CP handover within a gNB may be supported by Xn-U.

### Dual Connectivity

In dual connectivity, a UE capable of multiple transmission/receptions, may be connected to more than one RAN node. The RAN nodes may be of the same RAT (both master node and secondary node in NR or LTE respectively) or different RATs, e.g one master LTE node and one secondary NR node. In specification 3GPP TS 37.340 V17.1.0, available at https://portal.3gpp.org/desktopmodules/Specifications/SpecificationDetails.aspx?specificationId=3198 as of 26 Jul. 2023, the principles of multi-radio dual connectivity is described:

==============Start of excerpt from TS 37.340====================

### 4.1 General

### 4.1.1 Common MR-DC Principles

Multi-Radio Dual Connectivity (MR-DC) is a generalization of the Intra-E-UTRA Dual Connectivity (DC) described in TS 36.300 [2], where a multiple Rx/Tx capable UE may be configured to utilise resources provided by two different nodes connected via non-ideal backhaul, one providing NR access and the other one providing either E-UTRA or NR access. One node acts as the Master Node (MN) and the other as the Secondary Node (SN). The MN and SN are connected via a network interface and at least the MN is connected to the core network.

The MN and/or the SN can be operated with shared spectrum channel access.

All functions specified for a UE may be used for an IAB-MT unless otherwise stated. Similar as specified for UE, the IAB-MT can access the network using either one network node or using two different nodes with EN-DC and NR-DC architectures. In EN-DC, the backhauling traffic over the E-UTRA radio interface is not supported.

NOTE 1: MR-DC is designed based on the assumption of non-ideal backhaul between the different nodes but can also be used in case of ideal backhaul.

NOTE 2: All MR-DC normative text and procedures in this version of the specification show the aggregated node case. The details about non-aggregated node for MR-DC operation are described in TS 38.401.

4.1.2 MR-DC with the EPC

E-UTRAN supports MR-DC via E-UTRA-NR Dual Connectivity (EN-DC), in which a UE is connected to one eNB that acts as a MN and one en-gNB that acts as a SN. The eNB is connected to the EPC via the S1 interface and to the en-gNB via the X2 interface. The en-gNB might also be connected to the EPC via the S1-U interface and other en-gNBs via the X2-U interface.

The EN-DC architecture is illustrated in FIG. 3.

FIG. 3 depicts an EN-DC Overall Architecture.

4.1.3 MR-DC with the 5GC

### 4.1.3.1 E-UTRA-NR Dual Connectivity

NG-RAN supports NG-RAN E-UTRA-NR Dual Connectivity (NGEN-DC), in which a UE is connected to one ng-eNB that acts as a MN and one gNB that acts as a SN.

### 4.1.3.2 NR-E-UTRA Dual Connectivity

NG-RAN supports NR-E-UTRA Dual Connectivity (NE-DC), in which a UE is connected to one gNB that acts as a MN and one ng-eNB that acts as a SN.

### 4.1.3.3 NR-NR Dual Connectivity

NG-RAN supports NR-NR Dual Connectivity (NR-DC), in which a UE is connected to one gNB that acts as a MN and another gNB that acts as a SN. In addition, NR-DC can also be used when a UE is connected to two gNB-DUs, one serving the MCG and the other serving the SCG, connected to the same gNB-CU, acting both as a MN and as a SN.

==============End of excerpt from TS 37.340==============

The flows for setting up dual connectivity is described in chapter 10 of 3GPP TS 37.340:

FIG. 4 depicts a Secondary Node Addition procedure.

### Overview of the QoE Framework

### “Regular” QoE

Quality of Experience (QoE) measurements, also referred to as “application layer measurements”, have been specified for LTE and UMTS and are being specified for NR in 3GPP release 17. The purpose of the application layer measurements is to measure the end user experience when using certain applications. Currently QoE measurements for streaming services and for MTSI (Mobility Telephony Service for IMS) services are supported. For NR, it is likely that at least VR is added to the list of services for which QoE measurements are specified and supported.

The solutions in LTE and UMTS are similar with the overall principles as follows. Quality of Experience Measurement Collection (QMC) enables configuration of application layer measurements in the UE and transmission of QoE measurement result files (commonly referred to as QoE reports) to the network by means of RRC signalling. An application layer measurement configuration (also called QoE measurement configuration or QoE configuration) that the RAN receives from the OAM system or the CN is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to the network in an uplink RRC message. The RAN then forwards the QoE report to a Measurement Collector Entity (MCE).

In 3GPP release 17 a new study item for “Study on NR QoE management and optimizations for diverse services” for NR has been approved and concluded. The specification work for 3GPP release 17 is still ongoing. The purpose of the study item is to study solutions for QoE measurements in NR. QoE management in NR will not just collect the quality of experience parameters of streaming services but also consider the typical performance requirements of diverse services (e.g. AR/VR and URLLC, of which at least VR seems to be covered in 3GPP release 17). Based on requirements of services, the NR study also included more adaptive QoE management schemes that enable network optimization to satisfy user experience for diverse services.

The configuration data related to QoE measurements (in standard specifications typically referred to as application layer measurements) comprises a service type indication, an indication of an area in which the measurements are to be performed (denoted area scope), an IP address of the entity the collected measurement results (i.e. the QoE reports) should be sent to (often referred to as a MCE, spelled out as Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE and are placed in a “container” which the network entities handling it, e.g. forwarding it to the UE, as well as the UE Access Stratum, cannot interpret and do not try to read. The currently specified service types are MTSI and streaming service (DASH), and in 3GPP release 17, at least service type VR will be added. An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE, and in particular QoE configuration, comes in two types: management-based QoE configuration and signaling-based QoE configuration. In both cases the QoE configuration originates in the OAM system or some other administrational entity, e.g. dealing with customer satisfaction. All of these entities are in this document referred to as the OAM system (where the OAM system also comprises further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system is interested in collecting QoE measurement results from a specific UE, e.g. because the user of the UE has filed a complaint. The OAM system sends the s-based QoE configuration to the HSS (in EPS/LTE) or UDM (in 5GS/NR), which forwards the QoE configuration to the UE's current core network node (CN), e.g. an MME in EPS/LTE or an AMF in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms. In NR and LTE, a globally unique QoE reference (formed of MCC+MNC+QMC ID, where the QMC ID is a string of 24 bits) will be associated with each QoE configuration. The QoE reference is included in the container with measurement instructions and also sent to the RAN (i.e. the gNB in NR). For the communication between the gNB and the UE, the QoE reference is replaced by a shorter identifier denoted as measConfigAppLayerId, which is locally unique within a UE (i.e. there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting can be configured to be periodic or only sent at the end of an application session. Furthermore, the RAN can instruct the UE to pause QoE reporting, e.g. in case the cell/gNB is in a state of overload.

The RAN is not aware of when an application session with an associated QoE measurement session is ongoing and the UE Access Stratum is also not automatically aware of this. To alleviate this session start/stop indications can be introduced, which will be sent from the application layer in the UE to the UE AS and from the UE AS to the RAN. A session stop indication may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE)

In NR, 3GPP Rel-17 introduced RAN visible QoE measurements, and a general description can be found in 3GPP TS 38.300 v17.0.0 clause 21.4.

RAN visible QoE measurements are configured by the NG-RAN node, where a subset of QoE metrics is reported from the UE as an explicit IE readable by the NG-RAN node. RAN visible QoE measurements (e.g., RAN visible QoE metrics, RAN visible QoE values) could be utilized by the NG-RAN node for network optimization. RAN visible QoE measurements are supported for the DASH streaming and VR services. The NG-RAN node configures the RAN visible QoE measurement to collect all or some of the available RAN visible QoE metrics, where the indication of metric availability is received from the OAM or CN. The set of available RAN visible QoE metrics is a subset of the metrics which are already configured as part of QoE measurement configuration encapsulated in the transparent container. The PDU session ID(s) corresponding to the service that is subject to QoE measurements can also be reported by the UE along with the RAN visible QoE measurement results.

A request for collecting QoE measurements not visible to RAN (also called OAM-QoE in R3-223290) is started from OAM and identified by a QoE Reference. A definition for this identifier can be found e.g. in 3GPP TS 28.405 v17.1.0, available at https://portal.3gpp.org/desktopmodules/Specifications/SpecificationDetails.aspx?specific ationId=3265 as of 26 Jul. 2023, clause 5.2:

The QoE reference parameter specifies the network request session. The QoE reference shall be globally unique therefore it is composed as follows:
MCC+MNC+QMC ID, where the MCC and MNC are coming with the QMC activation request from the management system to identify one PLMN containing the management system, and QMC ID is a 3 byte Octet String.
The QMC ID is generated by the management system or the operator.
It is used to identify the QoE measurement collection job in the traffic nodes and in the measurement collection centre.

The UE AS layer can report to a gNB the RAN visible QoE measurements in RRC format and a UE Application Layer can be configured for performing more application layer measurements at the same time (in NR Rel-17 up to 16) and, e.g. in 3GPP TS 38.331 V17.2.0, available at https://portal.3gpp.org/desktopmodules/Specifications/SpecificationDetails.aspx?specific ationId=3197 as of 26 Jul. 2023, an application layer measurement is identified by the MeasConfigAppLayerId IE.

In a gNB, RAN visible QoE information can be transferred from gNB-CU to the gNB-DU in a procedure described in TS 38.473 v17.0.0, available at https://portal.3gpp.org/desktopmodules/Specifications/SpecificationDetails.aspx?specific ationId=3260 as of 26 Jul. 2023. The procedure is UE-associated, i.e. it is specific for a UE.

### 8.16.1 QoE Information Transfer

The purpose of the QoE Information Transfer procedure is to transfer RAN visible QoE information from the gNB-CU to the gNB-DU. The procedure uses UE-associated signalling.

FIG. 5 depicts a QoE Information Transfer procedure.

The gNB-CU initiates the procedure by sending the QOE INFORMATION TRANSFER message to the gNB-DU.

If the QoE Information List IE is included in QOE INFORMATION TRANSFER message, the gNB-DU may take it into account according to TS 38.300 [6].

### QoE Information Transfer

This message is sent by a gNB-CU to a gNB-DU, to indicate information related to RAN visible QoE.

Direction: gNB-CU→gNB-DU.

| | | | IE type and | | | Assigned |
|---|---|---|---|---|---|---|
| IE/Group Name | Presence | | reference | Semantics | Criticality | Criticality |
| Message Type | M | Range | 9.3.1.1 | description | YES | ignore |

| | | | | |
|---|---|---|---|---|
| gNB-CU UE | M | 9.3.1.4 | YES | reject |
| F1AP ID | | | | |
| gNB-DU UE | M | 9.3.1.5 | YES | reject |
| F1AP ID | | | | |
| QoE Information | | 0 . . . 1 | YES | ignore |
| List | | | | |
| >QoE Information | | 1 . . . <maxnoofQoEIn- | Each | ignore |
| Item | | formation> | | |
| >>QoE Metrics | O | 9.3.1.260 | — | — |

| Range bound | Explanation |
|---|---|
| maxnoofQoEInformation | Maximum no. of QoE information for one UE, the |
| | maximum value is 16. |

### QoE Metrics

This IE provides the RAN visible QoE measurement report to gNB-DU.

| | | | | |
|---|---|---|---|---|
| IE/Group | | | IE type and | Semantics |
| Name | Presence | Range | reference | description |

| | | | |
|---|---|---|---|
| Buffer Level | O | OCTET | As defined in TS |
| | | STRING | 38.331 [8]. |
| Playout Delay | O | OCTET | As defined in TS |
| | | STRING | 38.331 [8]. |

In the contribution R3-223128 to 3GPP TSG-RAN WG3 Meeting #116-e, available at https://www.3gpp.org/dynareport?code=Meetings-R3.htm&Itemid=408 as of 26 Jul. 2023, the association of RAN visible QoE report to a reference is discussed:

In F1AP a list containing currently agreed RVQoE metric is transferred over F1 using UE-associated signalling. But the reports are not associated with e.g. any reference or other id. So the gNB-DU will not know how many different application sessions that provide reports, and the currently defined signalling will therefore not allow the gNB-DU to distinguish between QoE reports coming from the different application sessions. Also, the gNB-DU will not be able to group reports that it successively receives from a given application session and will therefore not be able to trace e.g. any tendencies in the reported data.

Candidate reference or other ID that could solve this issue would typically be the QoE reference or the short RRC id (measConfigAppLayerId) allocated by the UE. In the F1AP CR submitted to the present meeting in R3-223131, we propose to use the QoE reference, but the ultimate choice may be subject for further evaluation.

In the same contribution, the following proposal is made according to the reported discussion:

Proposal 3: RAN3 to discuss and agree on identifying RVQoE report information over F1 using QoE Reference or short RRC id (measConfigAppLayerId).

### Signalling Radio Bearer (SRB)

Signalling Radio Bearers are configured in the UE for transmission of a control plane message to and from the UE. In current specifications five different SRBs may be configured. SRB0 is used for initial RRC setup, before any security is activated. SRB1 is used for most RRC messages and SRB2 for NAS messages.

If the UE is configured with dual connectivity (DC), SRB1 is used for communicating with the Master Node (MN). The UE may in DC also be configured with SRB3, which is used for direct communication between the UE and the Secondary Node (SN).

For the transmission of QoE and RVQoE reports, a dedicated SRB4 has been defined. SRB4 is in Rel-17 only being used for transmission of QoE and RVQoE reports in the RRC message MeasurementReportAppLayer, to a Master Node.

There currently exist certain challenge(s).

In published technology, some problems related to the handling of QoE measurements in case of MR-DC have been identified and some methods described that partially address such handling.

For example, at RAN3 #117-e, with reference to R3-225235, the following scenarios have been identified, for m-based QoE:

M-based QoE configuration is only received by MN;

M-based QoE configuration is only received by SN;

M-based QoE configuration is received by both MN and SN

At RAN3 #117-e meeting, it has been discussed whether only one of the two nodes

(e.g. the Master Node, MN) should always be the node configuring a UE for QoE/RVQoE measurement, if any of the two nodes (MN and Secondary Node, SN) can each configure the UE for QoE measurements, and whether one of the two nodes (e.g. the SN node) can pass the QoE/RVQOE configuration to the other node and let the other node configure the UE.

The need for a coordination between the two network nodes involved in NR-DC has been identified but actual details on how this can be achieved have been left for further discussion.

In particular, the following point was captured at RAN3 #117-e as to be resolved:

FFS whether a common or independent RVQoE configuration for MN and SN is sent to the UE.

The above problem follows from the fact that it is unknown, before the session starts, whether the RAN node that assembled the RVQoE configuration (and optionally sent it to the UE, directly or via another RAN node) is the same as the RAN node that is going to deliver the data for the application session to the UE. In general, the node that delivers the session should be both assembling the RVQOE configuration and receiving the RVQoE reports.

Certain aspects of the disclosure and their embodiments may provide solutions to these or other challenges. For example, certain aspects of the disclosure and their embodiments may ensure that a UE in NR-DC applies, for the RVQOE measurements, the RVQoE configuration that is assembled by the RAN node (MN or SN) that is delivering the data for the application session to the UE. Certain aspects ensure that the RAN node that is delivering the data for the session participated in the assembly of the configuration. In particular, it is an object of some embodiments to facilitate RVQoE measurements in NG-RAN networks.

Certain embodiments may provide one or more of the following technical advantage(s). Certain embodiments may ensure that a UE in NR-DC applies, for the RVQOE measurements, either the RVQoE configuration that is assembled by the RAN node (MN or SN) that is delivering the data for the application session to the UE, or a configuration that was assembled at least partly by said RAN node. In these embodiments, since this is the RAN node that will also be receiving the RVQoE reports, an advantage is that the consumer of the RVQoE reports is the node that assembled or participated in assembling the RVQoE configuration.

### SUMMARY OF INVENTION

In a first aspect of the present invention, a method is performed by a user equipment (UE). The method comprises receiving a first message comprising a first RAN-Visible Quality of Experience (RV-QoE) configuration of a first network node. The method further comprises receiving a second message comprising a second RV-QoE configuration of a second network node and determining whether the first network node or the second network node is delivering data for a session. The method further comprises using the RV-QoE configuration of the determined network node to make RV-QoE measurements.

In a second aspect of the present invention, a method is performed by a first network node in a communications network. The method comprises sending a first message comprising an indication of a first Radio Access Network-Visible (RAN-Visible) Quality of Experience (RV-QoE) configuration of the first network node, to a second network node, wherein the first message indicates to the second network node that the first network node has configured a User Equipment (UE) for RV-QoE measurements.

In a third aspect of the present invention, a method is performed by a second network node in a communications network. The method comprises receiving a first message comprising an indication of a first RAN-Visible Quality of Experience, RV-QoE configuration of the first network node, to a second network node, wherein the first message indicates to the second network node that the first network node has configured a User Equipment, UE, for RV-QoE measurements.

In a fourth aspect of the present invention, a user equipment comprises processing circuitry and memory coupled to the processing circuitry, wherein the memory includes instructions that when executed by the processing circuitry cause the user equipment to perform the steps of: receiving a first message comprising a first Radio Access Network-Visible (RAN-Visible) Quality of Experience (RV-QoE) configuration of a first network node, receiving a second message comprising a second RV-QoE configuration of a second network node, determining whether the first network node or the second network node is delivering data for a session, and using the RV-QoE configuration of the determined network node to make RV-QoE measurements.

In a fifth aspect of the present invention, a first network node comprises processing circuitry and memory coupled to the processing circuitry, wherein the memory includes instructions that when executed by the processing circuitry cause the first network node to perform the steps of: sending a first message comprising an indication of a first Radio Access Network-Visible (RAN-Visible) Quality of Experience (RV-QoE) configuration of the first network node, to a second network node, wherein the first message indicates to the second network node that the first network node has configured a User Equipment, UE, for RV-QoE measurements.

In a sixth aspect of the present invention, a second network node comprises processing circuitry and memory coupled to the processing circuitry, wherein the memory includes instructions that when executed by the processing circuitry cause the second network node to perform the steps of: receiving a first message comprising an indication of a first RAN-Visible Quality of Experience, RV-QoE configuration of the first network node, to a second network node, wherein the first message indicates to the second network node that the first network node has configured a User Equipment, UE, for RV-QoE measurements.

In a seventh aspect of the present invention, a communication system comprises at least one of the following: a user equipment as defined in the fourth aspect, a first network node as defined in the fifth aspect, and/or a second network node as defined in the sixth aspect.

In a eighth aspect of the present invention, a user equipment comprises a first message receiver configured to receive a first message comprising a first Radio Access Network-Visible, RAN-Visible, Quality of Experience, RV-QoE, configuration of a first network node. The user equipment further comprises a second message receiver configured to receive a second message comprising a second RV-QoE configuration of a second network node. The user equipment further comprises a determination unit configured to determine whether the first network node or the second network node is delivering data for a session, and a user unit configured to use the RV-QoE configuration of the determined network node to make RV-QoE measurements.

In a ninth aspect of the present invention, a first network node comprises a sending unit configured to send a first message comprising an indication of a first Radio Access Network-Visible, RAN-Visible, Quality of Experience, RV-QoE, configuration of the first network node, to a second network node, wherein the first message indicates to the second network node that the first network node has configured a User Equipment, UE, for RV-QoE measurements.

In a tenth aspect of the invention, a second network node comprises a receiving unit configured to receive a first message comprising an indication of a first RAN-Visible Quality of Experience, RV-QoE configuration of the first network node, to a second network node, wherein the first message indicates to the second network node that the first network node has configured a User Equipment, UE, for RV-QoE measurements.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows a known NG-RAN Overall Architecture;

FIG. 2 shows a known overall architecture for separation of gNB-CU-CP and gNB-CU-UP;

FIG. 3 shows a known EN-DC Overall Architecture;

FIG. 4 shows a known secondary node addition procedure;

FIG. 5 shows a known QoE Information Transfer procedure;

FIG. 6 shows a method performed by a wireless device according to embodiments of the disclosure;

FIG. 7 shows a method performed by a network node according to embodiments of the disclosure;

FIG. 8 shows a method performed by a second network node according to embodiments of the disclosure;

FIG. 9 shows an example of a communication system in accordance with some embodiments;

FIG. 10 shows a UE in accordance with some embodiments;

FIG. 11 shows a network node in accordance with some embodiments;

FIG. 12 is a block diagram of a host in accordance with various aspects described herein;

FIG. 13 is a block diagram illustrating a virtualization environment in which functions implemented by some embodiments may be virtualized; and

FIG. 14 shows a communication diagram of a host communicating via a network node with a UE over a partially wireless connection in accordance with some embodiments.

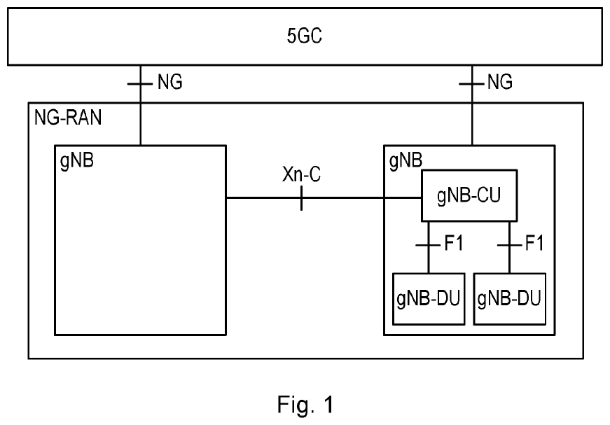

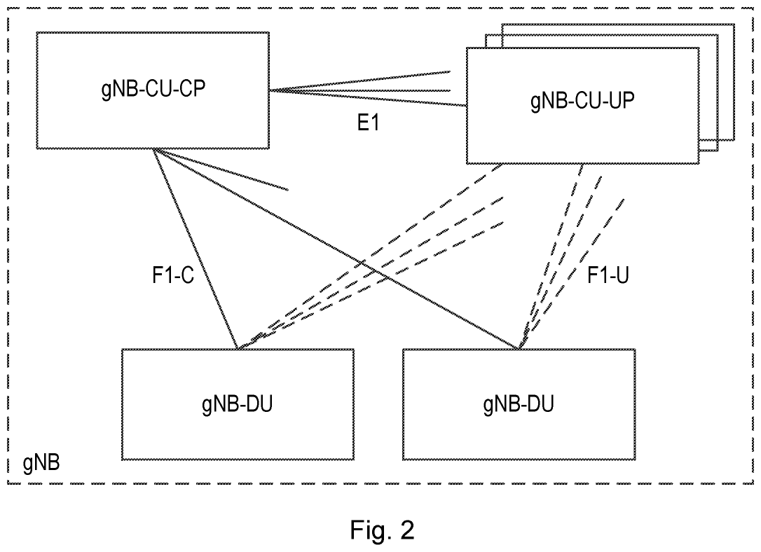

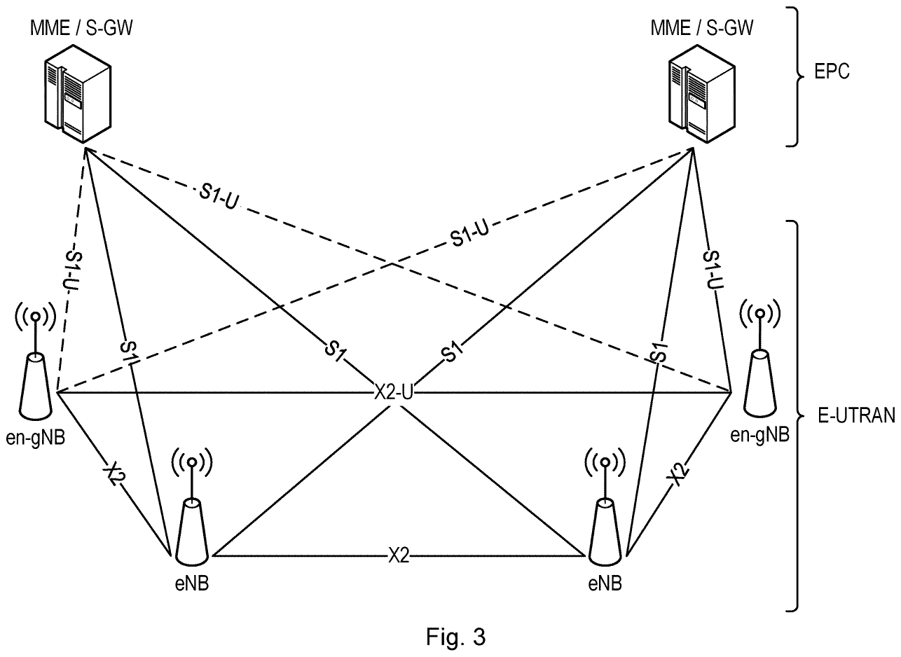

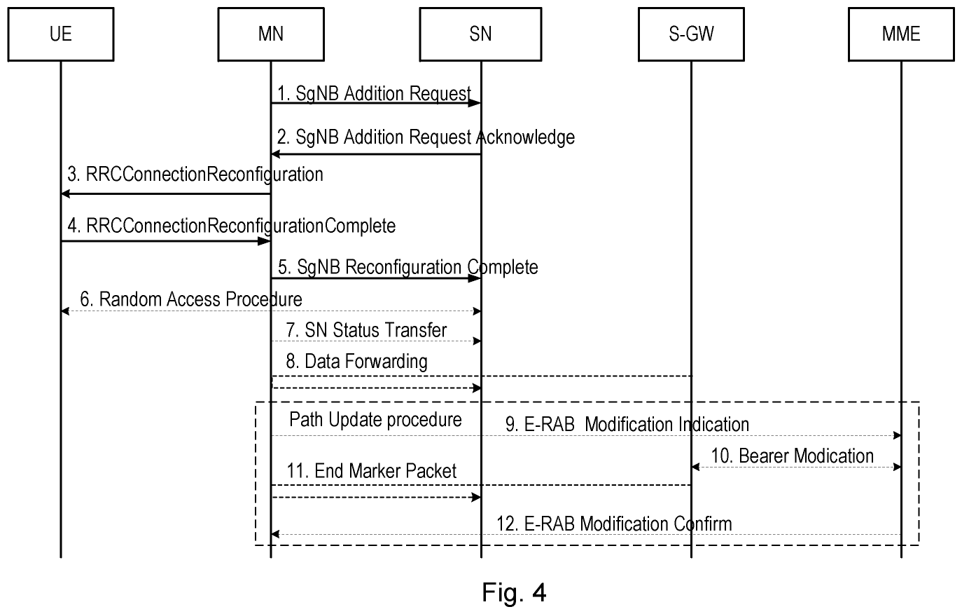

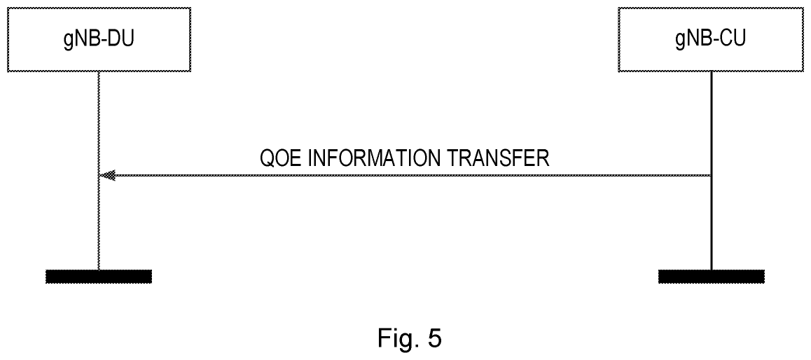

### DETAILED DESCRIPTION

Embodiments herein ensure that the RAN node (the MN or the SN) carrying the application session and receiving the RVQoE reports is the node that assembled the RVQoE measurement configuration or at least participated in its assembly.

Some of the embodiments contemplated herein will now be described more fully with reference to the accompanying drawings. Embodiments are provided by way of example to convey the scope of the subject matter to those skilled in the art.

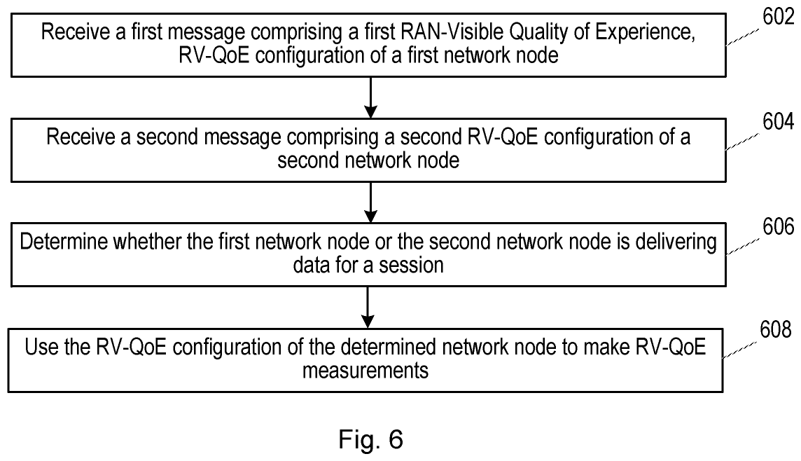

FIG. 6 depicts a method in a User Equipment accordance with some embodiments.

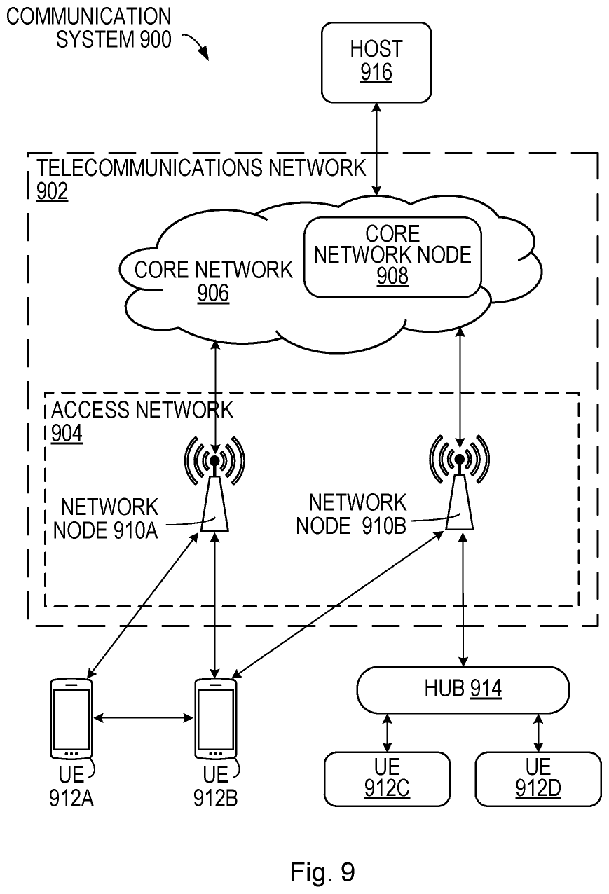

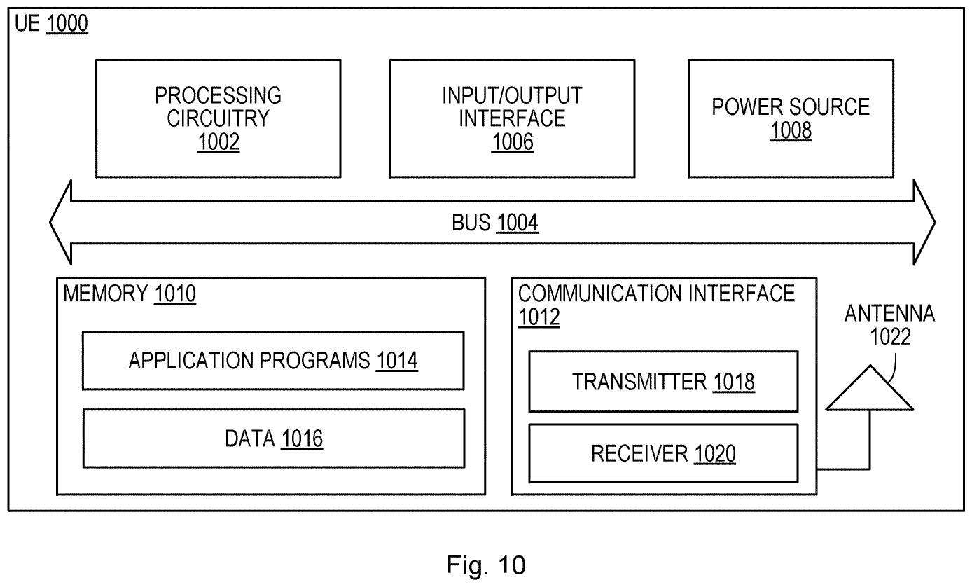

FIG. 6 depicts a method in accordance with particular embodiments. The method 6 may be performed by a UE or wireless device (e.g. the UE 912 or UE 1000 as described later with reference to FIGS. 9 and 10 respectively). The method begins at step 602 with the UE receiving a first message comprising a first RAN-Visible Quality of Experience, RV-QoE configuration of a first network node. At step 604 the method comprises receiving a second message comprising a second RV-QoE configuration of a second network node. In step 606 the method comprises determining whether the first network node or the second network node is delivering data for a session (e.g. such as a session supported or provided by the UE). In step 608 the method comprises using the RV-QoE configuration of the determined network node to make RV-QoE measurements. In this way, RV-QoE measurements are obtained and reported according to the configuration of the network node providing the session.

In this embodiment, pertaining to the case when both the first and the second RVQOE configuration are sent to the UE, the UE receives and stores both RVQoE configurations. The two configurations may or may not be in conflict. After the application session starts at the UE, the UE realizes which of the two RAN nodes is delivering the data for the session and applies the corresponding RVQOE configuration, i.e., starts the corresponding RVQoE measurements based on the RVQoE configuration assembled by the node which assembled it or took part in assembling it. For example, if the session is carried by the MN, the UE activates the first RVQoE configuration (which was assembled by and received from the MN). The UE may realize which node carries the application session, e.g., based on the DRB ID and/or PDU session ID and/or QoS flow ID.

In one variant, the UE applies the chosen RVQoE configuration before starting the RVQOE measurements. In another variant, if needed, it applies the chosen RVQoE configuration after starting the RVQoE measurements.

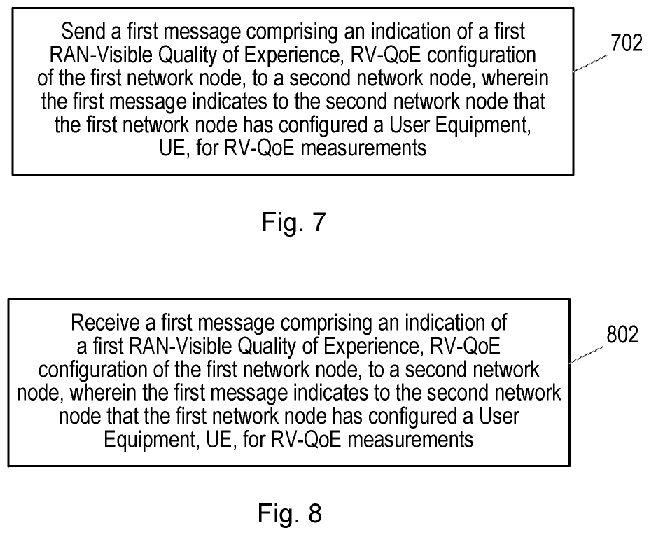

FIG. 7 depicts a method performed by a first network node in a communications network in accordance with some embodiments.

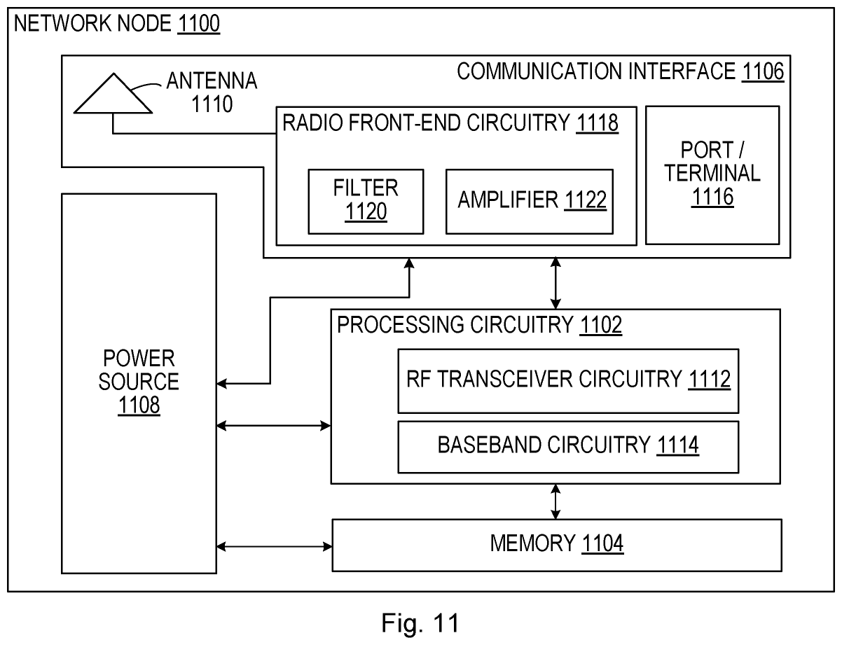

FIG. 7 depicts a method in accordance with particular embodiments. The method 7 may be performed by a network node (e.g. the network node 910 or network node 1100 as described later with reference to FIGS. 9 and 11 respectively). The method begins at step 702 with sending a first message comprising an indication of a first RAN-Visible Quality of Experience, RV-QoE configuration of the first network node, to a second network node, wherein the first message indicates to the second network node that the first network node has configured a User Equipment, UE, for RV-QoE measurements.

The step of sending the first message is performed as part of a procedure to add the second network node as a secondary network node in a multi-radio dual connectivity (MR-DC) procedure for the UE.

In one embodiment, a first RAN node (in the future role of Master Node (MN) in the context of MR-DC operation), upon initiating a procedure to add a second RAN node in the role of Secondary Node (SN), provides the SN node with indications of RVQoE configuration of the first RAN node (as described below) to signal to the SN node that the MN node has configured a UE for RVQoE measurements.

In one variant, the first RAN node sends an RVQoE configuration (the first RVQoE configuration) to the UE while the UE is still in single connectivity. In another variant, the RVQoE configuration is sent to the UE after dual connectivity is established or as part of a procedure/message to setup multi connectivity configuration or as part of a procedure to modify a multi connectivity configuration. In any case, the RVQoE configuration can be sent to the UE only upon/after configuring the UE with the corresponding QoE configuration, comprising application layer measurement configuration encapsulated in a container transparent to RAN, has been received by the RAN node from the OAM (directly or indirectly via AMF).

Separately or additionally, the first network node may send a second message to the second network node to request that the second network node sends an indication of a second RV-QoE configuration of the second network node, to the first network node. This may be performed as part of the method shown in FIG. 7 (e.g. as another step). It may alternatively be performed or as a stand alone method, e.g. independently of the steps shown in FIG. 7.

Upon receiving the second RV-QoE configuration, the method may further comprise: determining whether there is a conflict between the first RV-QoE configuration and the second RV-QoE configuration.

It can be determined that a conflict is present if: a first QoE configuration identifier in the first RV-QoE configuration is the same as a second QoE configuration identifier in the second RV-QoE configuration; a first reporting periodicity in the first RV-QoE configuration for a first service type is different to a second reporting periodicity in the second RV-QoE configuration for the first service type; a first reporting trigger in the first RV-QoE configuration for the first service type is different to a second reporting trigger in the second RV-QoE configuration for the first service type; a first requested reporting periodicity for a first RV-QoE metric in the first RV-QoE configuration is different to a second requested reporting periodicity for the first RV-QoE metric in the second RV-QoE configuration; reporting is periodic in the first RV-QoE configuration and initiated by a trigger in the second RV-QoE configuration; reporting periodicity is configured in the first RV-QoE configuration and not configured for the second RV-QoE configuration; and/or measurements are stored according to the first RV-QoE configuration and reported periodically in the second RV-QoE configuration. Other conflicts are described in the description below.

In response to determining that the first RV-QoE configuration and the second RV-QoE configuration have one or more configuration parameters in common, the method may further comprise: determining an action to perform. Actions are described in detail in the text below

In some embodiments, in response to determining a conflict between the first RV-QoE configuration and the second RV-QoE configuration, the method may further comprise obtaining (e.g. forming or creating) a resolved RV-QoE. The resolved RV-QoE may be obtained as a result of: discarding one of the first RV-QoE configuration and the second RV-QoE configuration; remove one or more third RV-QoE metrics or third RV-QoE values from the first RV-QoE configuration; remove one or more fourth RV-QoE metrics or fourth RV-QoE values from the second RV-QoE configuration; align the first requested reporting periodicity for a first RV-QoE metric in the first RV-QoE configuration and the second requested reporting periodicity for the first RV-QoE metric in the second RV-QoE configuration; if the conflict arises because in one of the first RV-QoE configuration and the second RV-QoE configuration, the reporting is periodic, while in the other of the first RV-QoE configuration and the second RV-QoE configuration, the reporting is event-triggered, selecting a new reporting mechanism to resolve the conflict; and/or if the conflict arises because in one of the first RV-QoE configuration and the second RV-QoE configuration, the reporting is not specified, using the one of the first RV-QoE configuration and the second RV-QoE configuration that does specify the reporting mechanism, in order to resolve the conflict.

In some embodiments, the method further comprises sending the resolved RV-QoE to the UE and/or to the second network node.

In some embodiments, the method comprises, in response to determining a conflict between the first RV-QoE configuration and the second RV-QoE configuration, discarding RV-QoE reports associated with one of the first RV-QoE configuration and the second RV-QoE configuration.

The method may further comprise merging the first RV-QoE configuration and the second RV-QoE configuration to obtain a merged RV-QoE configuration; and sending a third message comprising the merged RV-QoE configuration to the UE.

The method may further comprises: configuring the UE with the first RV-QoE configuration of the first network node, or part thereof; or configuring the UE with the second RV-QoE configuration of the second network node, or part thereof.

In some embodiments, the first network node sends a fourth message to the second network node, the fourth message indicating whether a conflict has been detected between the first RV-QoE configuration and the second RV-QoE configuration; and/or one or more actions associated with, or modifications to, the second RV-QoE configuration that the first network node has made to the second RV-QoE configuration.

As noted above, the first network node may be a master node (MN) in a multi-radio dual connectivity (MR-DC) procedure for the UE and the second network node is a secondary node in the MR-DC procedure. Alternatively, the second network node is a master node (MN) in a multi-radio dual connectivity (MR-DC) procedure for the UE and the first network node is a secondary node in the MR-DC procedure.

FIG. 8 depicts a method in a second network node in accordance with some embodiments

FIG. 8 depicts a method in accordance with particular embodiments. The method 802 may be performed by a second network node such as a core network node, or any other network node described herein.

The method 802 comprises receiving a first message comprising an indication of a first RAN-Visible Quality of Experience, RV-QoE configuration of the first network node, to a second network node, wherein the first message indicates to the second network node that the first network node has configured a User Equipment, UE, for RV-QoE measurements.

The method 802 may further comprise steps of: receiving a second message requesting that the second network node sends an indication of a second RV-QoE configuration of the second network node, to the first network node; and sending the requested second RV-QoE configuration of the second network node, to the first network node.

### TERMINOLOGY, DISCLAIMERS, AND GENERALIZATIONS

In more detail, A RAN node can be a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Non-Real Time RAN Intelligent Controller (Non-RT RIC), a Real-Time RAN Intelligent Controller (RT-RIC).

The solution herein is described on an example of two RAN nodes serving the UE in NR-DC, but it can be generalized to an arbitrary number of nodes simultaneously serving the UE.

The solution herein is described on an example of NR-DC, but it can be generalized to Multi Radio Dual Connectivity (MR-DC) or to connectivity options with more than two RAN nodes as well.

The term “service” is often used as a short notation for “service type”, therefore “service” and “service types” can be seen as interchangeable unless explicitly stated.

The solution proposed in this invention applies to both signaling- and/or management-based QoE measurements.

The terms “RVQoE configuration” and “QoE measurement configuration” are used interchangeably.

The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

The terms “access stratum” and “radio layer” are used interchangeably when referring to a UE.

The term “session” may refer to either a QoE measurement session or an application session or an application session for which QoE measurement is applied.

The term “session” may refer to either a QoE measurement session or an application session or an application session for which QoE measurement is applied.

The solution proposed in this invention applies to UMTS, LTE and NR as well as future RATs such as 6G.

The solution is described on the example of RVQOE measurements, but at least some of the embodiments are equally applicable to QoE measurements.

The RAN node responsible to resolve potential conflict has been described with focus on MN, but it is not prevented in the invention that the role can be taken by the SN.

To implement the inter-node coordination described herein, either an enhanced existing or a new XnAP procedure(s) can be used.

The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration comprising of an XML file containing instructions of QoE metrics to be collected etc.

In this invention, two or more network nodes are used in Multi-Radio Dual Connectivity (MR-DC) operation for a UE. Of the possible MR-DC scenarios, the case of NR-DC is described for simplicity, although it should not be regarded as limiting. In other words, the invention is applicable to other MR-DC scenarios as well, such as EN-DC, NE-DC.

The present invention is applicable to procedures/messages related to the handling of multi-connectivity operations (e.g., to setup, modify or release multi-connectivity), in any possible combination in terms e.g. of: whether it is an MN initiated procedure, or an SN initiated procedure, whether the checks on presence of potential conflicts between RVQOE configuration is done by the RAN node in the MN role or the SN role. So, for example, the invention is applicable to the case of S-NG-RAN node Modification for the M-NG-RAN node initiated procedure, as well as to the case of S-NG-RAN node initiated procedure. Likewise, the invention is applicable to the case of an MN node being responsible to provide to a UE one or more RVQoE configurations resulting from a determination process where an RVQoE configuration which the SN node would like to apply to the UE via the MN, can be accepted/considered as valid by the MN and sent to the UE, just forwarded from the MN to UE, discarded and not sent to the UE, or manipulated by the MN, e.g., modified or merged with an already existing (or being prepared) RVQoE configuration at the MN side and then sent to the UE.

In one embodiment, a first RAN node (in the future role of Master Node (MN) in the context of MR-DC operation), upon initiating a procedure to add a second RAN node in the role of Secondary Node (SN), provides the SN node with indications of RVQOE configuration of the first RAN node to signal to the SN node that the MN node has configured a UE for RVQoE measurements.

In one embodiment, the first RAN node sends an RVQoE configuration (the first RVQoE configuration) to the UE while the UE is still in single connectivity. In another example, the RVQoE configuration is sent to the UE after dual connectivity is established or as part of a procedure/message to setup multi connectivity configuration or as part of a procedure to modify a multi connectivity configuration. In any case, the RVQoE configuration can be sent to the UE upon/after configuring the UE with the corresponding QoE configuration, comprising application layer measurement configuration encapsulated in a container transparent to RAN, that has been received by the RAN node from the OAM (directly or indirectly via AMF).

If a UE in single connectivity is performing RVQoE measurements, and during those measurements the DC is established, the MN may send an RVQoE configuration, either originating from the MN or from SN, or a merged RVQoE configuration, according to the embodiments described below.

In one embodiment, the first RAN node (MN) requests from the second RAN node (SN) indications of RVQoE configurations of the second RAN node. Some examples of indications of RVQoE configurations are described below.

In one embodiment, upon receiving the indication of a second RVQoE configuration of the second RAN node, the first RAN node (MN) may determine one or more of the following:
whether a conflict is detected between the first RVQoE configuration and the second RVQOE configuration
   a conflict may be detected if at least one the conditions below is fulfilled for two RVQoE configurations, a first RVQoE configuration of the first RAN node, and a second RVQoE configuration of the second RAN node:
      for the first RVQOE configuration and the second RVQoE configuration, at least one of the QoE configuration identifiers is the same (e.g., the same QoE reference ID, or the same MeasConfigAppLayerId);
      the requested reporting periodicities and/or triggering events for the same service type sending RVQoE reports in the first RVQoE configuration and the second RVQoE configuration are different;
      the requested recording periodicity for the same RVQoE metric, e.g. buffer level for streaming or VR, differ between the RVQoE configurations;
      Reporting in one RVQoE configuration is periodic, the second configuration-event-triggered, and vice versa;
      Reporting periodicity is configured for the first RVQoE configuration, and not configured for the second RVQoE configuration (or vice versa);
      Recording periodicity is configured for the first RVQoE configuration, and not configured for the second RVQoE configuration (or vice versa);
      Measurements according to the first RVQOE configuration are stored,
   while in the second RVQoE-reported periodically, and vice versa;
the action to perform in case the first RVQOE configuration and the second RVQoE configurations have one or more configuration parameters in common (except for the case of the same QoE configuration identifier, described above). For example, the first and the second RVQoE configuration points at the same service type, or one of the RVQoE configuration (say the first) is a superset of the other RVQoE configuration (say the second), in the sense that all the RVQOE metrics and/or RVQoE values configured in one RVQoE configuration are also present in the other RVQoE configuration, but not the opposite. Or, in another case, the periodicity of RVQOE reporting differs between the RVQoE configurations or the recording periodicity for the buffer level metric differs between the RVQoE configurations. Although it may not be precluded (as in the case of NR) to send to the UE multiple RVQoE configurations pertaining to the same service type, the MN can decide that, even if two RVQoE configurations are distinct in terms of identity, the UE should only be configured with one of them. A possible reason can be that the maximum number of RVQoE configurations with which a UE can be configured with has been reached
whether both the first and the second RVQoE configurations should be sent to the UE
whether to merge the first and the second RVQoE configuration
whether a merged configuration obtained from first and second RVQoE configuration should/should not be sent to the UE
whether the RVQoE configuration of the second RAN node can/shall be sent to the UE or not
whether a conflicting RVQoE configuration of the second RAN node shall/shall not be sent to the UE
whether a conflicting RVQoE configuration of the second RAN node shall/shall not be removed from the list of RVQOE configurations for the UE
whether a conflicting RVQoE configuration of the first RAN node shall/shall not be sent to the UE
whether a conflicting RVQoE configuration of the first RAN node shall/shall not be removed from the list of RVQoE configurations for the UE
whether RVQoE reports for a conflicting RVQoE configuration of the second RAN node shall/shall not be discarded
whether RVQoE reports for a conflicting RVQoE configuration of the first RAN node shall/shall not be discarded

In one embodiment, the first RAN node executes one or more of the following actions for RVQoE configuration:
resolves a conflict, if detected. Resolution of conflict may comprise one of the following:
   discard the second RVQOE configuration (alternatively the first RVQoE configuration)
   remove from the second RVQoE configuration one or more RVQoE metrics and/or RVQoE values
   remove from the first RVQoE configuration one or more RVQoE metrics and/or RVQoE values
   align the reporting periodicities to the minimum of the first and second reporting periodicity values (or the maximum, or to a value obtained first calculating an average value between the reporting periodicities and then selecting the closest value in the range of admittable values of the reporting periodicities, or the closest upper value, or the closer lower value in the range of admittable values)
   align the recording periodicities to the minimum of the first and second recording periodicity values (or the maximum, or to a value obtained first calculating an average value between the recording periodicities and then selecting the closest value in the range of admittable values of the recording periodicities, or the closest upper value, or the closer lower value in the range of admittable values)

If one of the RVQoE reporting is periodic, while the other is event-triggered (not periodic), the first RAN node may choose to discard the periodic and use the event-triggered RVQoE configuration (or vice versa)

If one of the RVQoE configuration comprises a reporting periodicity, and the other has no reporting periodicity specified, the first RAN node may choose to discard the RVQoE configuration without the reporting periodicity (or vice versa)

If one of the RVQoE configuration comprises a recording periodicity, and the other has no recording periodicity specified, the first RAN node may choose to discard the RVQoE configuration without the recording periodicity (or vice versa)
modify an existing first RVQoE configuration for the UE according to parameters comprised in a second RVQoE configuration of the second RAN node
remove the second RVQoE configuration of the second RAN node from the RVQoE configurations for the UE
remove one (or more) parameters of the first RVQoE configuration of the first RAN node
remove one (or more) parameters of the second RVQoE configuration of the second RAN node
discard RVQoE reports associated with the first RVQoE configuration
discard RVQoE reports associated with the second RVQoE configuration
send to the UE both the first RVQoE configuration and the second RVQoE configuration
merge the first and second RVQoE configurations (this is valid with/without detection of conflict)

The merger may comprise of creating a superset, or union, of the two RVQoE configurations.

If the reporting periodicity differs between the two RVQoE configurations, the first RAN node may choose to include the minimum of the two reporting periodicities in the merged RVQoE configurations. Alternatively, denoting the two reporting periodicities the first and the second RVQoE reporting periodicities, the first RAN node may include in the merged RVQoE configuration the greatest RVQoE reporting periodicity value which by multiplication by integer factors can result in both the first and the second RVQoE reporting periodicity (i.e. the first RVQoE reporting periodicity is an integer multiple of the RVQoE reporting periodicity value included in the merged RVQOE configuration, and the second RVQoE reporting periodicity is also an integer multiple of the RVQoE reporting periodicity value included in the merged RVQoE configuration.

If the recording periodicity for a RVQOE metric, e.g. the buffer level metric for streaming or VR, differs between the two RVQoE configurations, the first RAN node may choose to include the minimum of the two recording periodicities in the merged RVQOE configurations. Alternatively, denoting the two recording periodicities the first and the second recording periodicities, the first RAN node may include in the merged RVQOE configuration the greatest recording periodicity value which by multiplication by integer factors can result in both the first and the second recording periodicity (i.e. the first recording periodicity is an integer multiple of the recording periodicity value included in the merged RVQoE configuration, and the second recording periodicity is also an integer multiple of the recording periodicity value included in the merged RVQoE configuration.

If the first RVQoE configuration comprises a first set of RVQOE metrics and/or RVQOE values, and the second RVQoE configuration comprises a second set of RVQoE metrics and/or RVQOE values, the merge may comprise of the RVQOE metrics of the first RVQoE configuration and the RVQoE values of the second RVQoE configuration (or vice versa)

If the first RVQoE configuration comprises a first set of triggers for event-triggered RVQoE reporting, and the second RVQoE configuration comprises a second set of triggers for event-triggered RVQoE reporting, the merge may comprise both the first set and the second set of triggers for event-triggered RVQoE reporting.
if the first RVQoE configuration comprises a set of metrics that are used for event-triggered RVQoE reporting, while the second RVQoE configuration comprises a set of metrics that are recorded periodically, the merge may comprise of a union of those metrics and a node which would be sending the merged configuration to a UE/receiving the RVQoE report, either the first network node, or the second network node, may configure one of the following:
   the parameters in the merged configuration would be used as event-triggers for event-triggered reporting,
   The parameters in the merged configuration would be recorded/reported periodically.

After the merger the first RAN node may send the merged RVQoE configuration to the UE.

As one option, the merger may be performed by modifying an already existing RVQoE configuration, e.g. an RVQoE configuration the first RAN node may previously have provided to the UE, e.g. the first RVQoE configuration.

Optionally, the first RAN node may then send the merged RVQoE configuration to the second RAN node (which also indicates to the second RAN node that this merged RVQOE configuration has been, or will be, sent to the UE.
configure the UE with a first RVQoE configuration of the first RAN node, or part thereof
configure the UE with a second RVQoE configuration of the second RAN node, or part thereof
configure the UE with a merged RVQoE configuration

In one embodiment, the first RAN node may send one or more indications to the second RAN node (SN) indicating one or more of:
whether a conflict has been detected for at least one RVQoE configuration of the second RAN node
one or more of the actions for RVQoE configuration that the first RAN node (MN) has carried out (or will carry out, or is about to carry out) concerning a second RVQoE configuration of the second RAN node and the associated RVQoE reports.

In one embodiment, a second RAN node (which is about to assume the role of SN in the context of MR-DC operation), upon receiving a request to be added as Secondary Node (SN), may provide the MN node with indications of RVQoE configuration of the second RAN node (examples of indications of RVQoE configurations are provided below) to signal to the MN node that the SN node has configured a UE for RVQoE measurements or is about to configure RVQoE measurements for the UE. The provision of the indications of RVQoE configuration may be as per request from the MN or unsolicited.

In one embodiment, a second RAN node (SN) may receive from a first RAN node (SN) one or more indications concerning one or more of:
RVQoE configurations of the first RAN node
indications of conflicts between RVQoE configuration of the first RAN node and RVQoE configuration of the second RAN node
actions that the first RAN node has carried out (or will carry out, or is about to carry out) concerning RVQoE configurations of the second RAN node, as defined above.

In the embodiments above, it is the first RAN node (MN) detecting and resolving potential conflicts between first and second RVQoE configuration. The invention remains applicable when it is the SN in charge of detecting and resolving the potential conflicts between first and second RVQoE configuration.

Likewise, the actions described above that can be executed by the MN can be executed by the SN instead.

In one embodiment, pertaining to the case when both the first and the second RVQoE configuration are sent to the UE, the UE may receive and store both RVQoE configurations. The two configurations may or may not be in conflict. After the application session starts at the UE, the UE may determine or realize which of the two RAN nodes is delivering the data for the session and apply the corresponding RVQoE configuration, i.e., start the corresponding RVQoE measurements based on the RVQoE configuration assembled by the node which assembled it or took part in assembling it. For example, if the session is carried by the MN, the UE may activate the first RVQoE configuration (which was assembled by and received from the MN). The UE may realize which node carries the application session, e.g., based on the DRB ID and/or PDU session ID and/or QoS flow ID.

In one variant, the UE applies the chosen RVQoE configuration before starting the RVQOE measurements. In another variant, if needed, it applies the chosen RVQoE configuration after starting the RVQoE measurements.

If the SN was deactivated, a UE which while in NR-DC, received and performed the RVQOE measurements according to the merged RVQoE configuration, may receive the first RVQoE configuration from the MN/first network node, or continue the measurements according to the merged RVQoE configuration as long as the application session continues.

### Indications of RVQoE Configuration

Indications of RVQoE configuration may comprise one or more of:
Identifier(s) of RVQoE configuration(s) configured for the UE
Identifier(s) of QoE configuration(s) configured for the UE
one or more MeasConfigAppLayerId
one or more QoE reference ID
RVQoE configuration(s)
the number of RVQoE configurations that the sender (e.g., the MN node) has configured for the UE
the number of RVQoE configurations that the server (e.g., the MN node) reserved for the sender and/or for the receiver (e.g., the SN node)
a maximum number of RVQoE configurations that can be configured for the UE (in total or for the receiver, and/or for the sender)
an indication that a RVQoE configuration for a given service type has been sent to the UE
an indication that SRB4 (or another SRB to be used for obtaining RVQoE reports and/or application layer signaling from the UE) is currently being set up for the UE
an indication that an SRB4 (or another SRB to be used for obtaining RVQoE reports and/or application layer signaling from the UE) is set up towards the UE and the use of that SRB4 is inhibited (e.g. paused)
an indication indicating whether a session of an application corresponding to a RVQoE configuration is started or stopped
a request from one RAN node (e.g. the MN) to the other RAN node (e.g. the SN) to set up the SRB for receiving the RVQoE reports
a request from one RAN node (e.g. the MN) to the other RAN node (e.g. the SN) to modify the SRB configuration (e.g., the SRB4 configuration) to switch the RVQoE reporting from one RAN node to the other RAN node.
a request from one RAN node (e.g. the MN) to the other RAN node (e.g. the SN) to modify the SRB configuration (e.g., the SRB4 configuration) from allowing the RVQOE reporting only towards one RAN node to allowing the RVQoE reporting towards the two RAN node simultaneously (e.g. over MCG and SCG simultaneously).
UE identities for the UE configured by the RAN node for RVQoE measurements
the type of QoE/RVQoE configuration (signaling based or management based)
an indication that merging of RVQoE configuration is possible/has been done
an indication that RVQoE measurements are to be/are being aligned/correlated with radio measurements (e.g. MDT)

### Signalling Sequences and Message Updates

In some embodiments, a possible conflict in RVQoE configuration is resolved when the secondary node is setup or modified. In some embodiments, when an SN is added, the MN sends an S-NODE ADDITION REQUEST to the SN to be added and in the S-NODE ADDITION REQUEST the MN includes the RRC container CG-ConfigInfo. Similarly, in some embodiments, when an SN configuration is modified, the message S-NODE MODIFICATION REQUEST is sent to the SN, also containing the RRC container CG-ConfigInfo.

The RVQoE configuration may be added in XnAP message such as e.g. S-NODE ADDITION REQUEST or S-NODE MODIFICATION REQUEST.

Alternatively, the RVQoE configuration may be added to the CG-ConfigInfo.

The SN may use the RVQoE information received from the MN to determine the RVQoE configuration in the SN.

In a more advanced solution, additional information may be added in an XNAP message or in CG-ConfigInfo as described above, e.g. any requests from the MN to the SN on the SN configuration for RVQoE.

The SN may use the information received from the MN to determine the RVQoE configuration and avoid conflicts.

The SN replies to the MN in a message, e.g. S-NODE ADDITION REQUEST ACKNOWLEDGE or S-NODE ADDITION MODIFICATION REQUEST ACKNOWLEDGE, the message containing the RRC container CG-Config. The RVQoE configuration of the SN may be added in the XnAP message or in the CG-Config.

In a more advanced solution, additional information may be added in the XnAP message or in CG-Config, such as replies from the SN regarding RVQoE configuration, e.g. if certain requests from the MN were not possible to fulfill by the SN.

In one option, the SN may request modification of the RVQoE configuration in a message to the MN, such as e.g. S-NODE MODIFICATION REQUIRED. The S-NODE MODIFICATION REQUIRED also contains the RRC container CG-Config. Similar as above, any information related to RVQoE which the MN may need to know according to what has been described above may be added in the XnAP message S-NODE MODIFICATION REQUIRED or in the RRC container CG-Config.

### Examples of Implementations

In some non-limiting examples of implementation, the procedure/messages comprising indications of RVQoE configurations are the ones defined in 3GPP TS 38.423 v17.2.0, available at https://portal.3gpp.org/desktopmodules/Specifications/SpecificationDetails.aspx?specific ationId=3228 as of 26 Jul. 2023, such as: S-NG-RAN node Addition Preparation procedure, M-NG-RAN node initiated S-NG-RAN node Modification Preparation procedure, S-NG-RAN node initiated S-NG-RAN node Modification procedure, S-NG-RAN node initiated S-NG-RAN node Change procedure, M-NG-RAN node initiated S-NG-RAN node Release procedure, S-NG-RAN node initiated S-NG-RAN node Release procedure.

An example is illustrated below for the case of S-NG-RAN node Addition Preparation, with extension to existing S-NODE ADDITION REQUEST marked in bold, underlined, and italic.

### 9.1.2.1 S-Node Addition Request

This message is sent by the M-NG-RAN node to the S-NG-RAN node to request the preparation of resources for dual connectivity operation for a specific UE.

Direction: M-NG-RAN node→S-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node UE | M | | NG-RAN node | Allocated at the | YES | reject |
| XnAP ID | | | UE XnAP ID | M-NG-RAN | | |
| | | | 9.2.3.16 | node | | |
| ( . . . skip unchanged | | | | | | |
| part . . .) | | | | | | |
| F1-terminating | O | | ENUMERATED | This IE applies | YES | Reject |
| IAB-donor | | | (true, . . .) | only if the UE | | |
| Indicator | | | | is an IAB-MT. | | |
| RVQoE | O | | | This IE applies | YES | Ignore |
| Configuration | | | | to RVQoE | | |
| Information | | | | configuration(s) | | |
| > Max Number Of | O | | INTEGER | This IE indicates | | |
| Allowed RVQoE | | | (0 . . . 16, . . .) | the maximum | | |
| Configuration At SN | | | | allowed number | | |
| | | | | of RVQoE | | |
| | | | | configuration | | |
| | | | | the SN can | | |
| | | | | apply to the UE | | |
| > Number Of | O | | INTEGER | This IE indicates | | |
| RVQoE | | | (0 . . . 16, . . .) | the number | | |
| Configuration | | | | of RVQoE | | |
| At MN | | | | configuration | | |
| | | | | the MN | | |
| | | | | configured | | |
| | | | | for the UE | | |
| > Active RVQoE | O | | | This IE | | |
| Configuration List | | | | contains the | | |
| | | | | list of RVQoE | | |
| | | | | configuration | | |
| | | | | identifiers | | |
| | | | | configured | | |
| | | | | for the UE | | |
| >> Active RVQoE | M | | | This IE | | |
| Configuration Item | | | | contains the | | |
| | | | | list of RVQoE | | |
| | | | | configuration | | |
| | | | | identifiers | | |
| | | | | configured | | |
| | | | | for the UE | | |
| >>Measurement | O | | INTEGER | This IE indicates | | |
| Configuration | | | (0 . . . 15, . . .) | the identity of | | |
| Application | | | | the application | | |
| Layer ID | | | | layer | | |
| | | | | measurement | | |
| | | | | configuration, | | |
| | | | | as defined in | | |
| | | | | TS 38.331 [10]. | | |
| >>> Service Type | O | | ENUMERATED | The service | | |
| | | | (QMC for DASH | type associated | | |
| | | | streaming, QMC | to the RVQoE | | |
| | | | for MTSI, QMC | configuration | | |
| | | | for VR, . . .) | | | |
| >>> Reporting | O | | | | | |
| Periodicity | | | | | | |
| >>> QoE | O | | ENUMERATED | Indicates | | |
| Measurement Status | | | (ongoing, . . .) | whether the | | |
| | | | | QoE | | |
| | | | | measurement | | |
| | | | | has started. | | |

| Range bound | Explanation |
|---|---|
| maxnoofPDUSessions | Maximum no. of PDU sessions. Value is 256 |

| Condition | Explanation |
|---|---|
| ifSNterminated | This IE shall be present if there is at least one PDU |
| | Session Resource Setup Info - SN terminated in the |
| | PDU Session Resources To Be Added List IE. |

### 9.1.2.2 S-Node Addition Request Acknowledge

This message is sent by the S-NG-RAN node to confirm the M-NG-RAN node about the S-NG-RAN node addition preparation.

Direction: S-NG-RAN node→M-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN | M | | NG-RAN node | Allocated at the | YES | reject |
| node UE | | | UE XnAP ID | M-NG-RAN | | |
| XnAP ID | | | 9.2.3.16 | node | | |
| S-NG-RAN | M | | NG-RAN node | Allocated at the | YES | reject |
| node UE | | | UE XnAP ID | S-NG-RAN | | |
| XnAP ID | | | 9.2.3.16 | node | | |
| PDU Session | | 1 | | | YES | ignore |
| Resources | | | | | | |
| Admitted To Be | | | | | | |
| Added List | | | | | | |
| >PDU Session | | 1 . . . <maxnoofPDUSessions> | | NOTE: If | — | |
| Resources | | | | neither the | | |
| Admitted To Be | | | | PDU Session | | |
| Added Item | | | | Resource | | |
| | | | | Setup Response | | |
| | | | | Info - SN | | |
| | | | | terminated IE | | |
| | | | | nor the PDU | | |
| | | | | Session | | |
| | | | | Resource | | |
| | | | | Setup Response | | |
| | | | | Info - MN | | |
| | | | | terminated IE | | |
| | | | | is present in a | | |
| | | | | PDU Session | | |
| | | | | Resources | | |
| | | | | Admitted to be | | |
| | | | | Added Item | | |
| | | | | IE, abnormal | | |
| | | | | conditions as | | |
| | | | | specified in | | |
| | | | | clause 8.3.1.4 | | |
| | | | | apply. | | |
| >>PDU Session ID | M | | 9.2.3.18 | | — | |
| >>PDU Session | O | | 9.2.1.6 | | — | |
| Resource Setup | | | | | | |
| Response Info - | | | | | | |
| SN terminated | | | | | | |
| >>PDU Session | O | | 9.2.1.8 | | — | |
| Resource Setup | | | | | | |
| Response Info - | | | | | | |
| MN terminated | | | | | | |
| PDU Session | O | | | | YES | ignore |
| Resources Not | | | | | | |
| Admitted List | | | | | | |
| >PDU Session | O | | PDU Session | | — | |
| Resources Not | | | Resources Not | | | |
| Admitted List - | | | Admitted List | | | |
| SN terminated | | | 9.2.1.3 | | | |
| >PDU Session | O | | PDU Session | | — | |
| Resources Not | | | Resources Not | | | |
| Admitted List - | | | Admitted List | | | |
| MN terminated | | | 9.2.1.3 | | | |
| S-NG-RAN node to | M | | OCTET STRING | Includes the | YES | reject |
| M-NG-RAN node | | | | CG-Config | | |
| Container | | | | message or | | |
| | | | | the CG- | | |
| | | | | CandidateList | | |
| | | | | message as | | |
| | | | | defined in | | |
| | | | | subclause | | |
| | | | | 11.2.2 of TS | | |
| | | | | 38.331 [10]. | | |
| Admitted | O | | ENUMERATED | Indicates | YES | reject |
| Split SRBs | | | (srb1, srb2, | admitted SRBs | | |
| | | | srb1&2, . . .) | | | |
| RRC Config | O | | 9.2.3.72 | | YES | reject |
| Indication | | | | | | |
| Criticality | O | | 9.2.3.3 | | YES | ignore |
| Diagnostics | | | | | | |
| Location | O | | Target Cell | Contains | YES | ignore |
| Information | | | Global ID | information to | | |
| at S-NODE | | | 9.2.3.25 | support | | |
| | | | | localisation of | | |
| | | | | the UE | | |
| MR-DC Resource | O | | 9.2.2.33 | Information | YES | ignore |
| Coordination | | | | used to | | |
| Information | | | | coordinate | | |
| | | | | resource | | |
| | | | | utilisation | | |
| | | | | between | | |
| | | | | M-NG-RAN | | |
| | | | | node and | | |
| | | | | S-NG-RAN node. | | |
| Available | O | | ENUMERATED | Indicates the | YES | ignore |
| fast MCG | | | (true, . . .) | fast MCG | | |
| recovery | | | | recovery via | | |
| via SRB3 | | | | SRB3 is | | |
| | | | | enabled. | | |
| Direct | O | | ENUMERATED | Indicates direct | YES | ignore |
| Forwarding Path | | | (direct path | forwarding path | | |
| Availability | | | available, . . .) | is available | | |
| | | | | between the | | |
| | | | | target | | |
| | | | | S-NG-RAN | | |
| | | | | node and source | | |
| | | | | NG-RAN node | | |
| | | | | for intra-system | | |
| | | | | handover or | | |
| | | | | between the | | |
| | | | | target S-NG- | | |
| | | | | RAN node | | |
| | | | | and the | | |
| | | | | source SN. | | |
| SCG Activation | O | | 9.2.3.155 | | YES | ignore |
| Status | | | | | | |
| Conditional PSCell | O | | | | YES | ignore |
| Addition | | | | | | |
| Information | | | | | | |
| Acknowledge | | | | | | |
| >Candidate PSCell | | 1 | | | — | |
| List | | | | | | |
| >>Candidate | | 1 . . . <maxnoofPSCellCandidate> | | | — | |
| PSCell Item | | | | | | |
| >>>PSCell ID | M | | NR CGI | | — | |
| | | | 9.2.2.7 | | | |

| Range bound | Explanation |
|---|---|
| maxnoofPDUSessions | Maximum no. of PDU sessions. Value is 256 |
| maxnoofPSCellCandidate | Maximum no, of PSCell candidate. Value is 8 |

Alternatively to adding the information in XnAP message, the RVQoE information may be added in RRC containers as described in Signalling sequences and message updates. An example implementation to TS 38.331 is provided below. More IEs could be added similar as for the XnAP messages above.

### 11.2.2 Message Definitions

[ . . . ]

### —CG-ConfigInfo

This message is used by master eNB or gNB to request the SgNB or SeNB to perform certain actions e.g. to establish, modify or release an SCG. The message may include additional information e.g. to assist the SgNB or SeNB to set the SCG configuration. It can also be used by a CU to request a DU to perform certain actions, e.g. to establish, or modify an MCG or SCG.

Direction: Master eNB or gNB to secondary gNB or eNB, alternatively CU to DU.

### CG-Config Message

-- ASN1START
-- TAG-CG-CONFIG-START

| | |
|---|---|
| CG-Config ::= | SEQUENCE { |

| | |
|---|---|
| criticalExtensions | CHOICE { |
| c1 | CHOICE{ |

| | |
|---|---|
| cg-Config | CG-Config- |

```
IEs,
      spare3 NULL, spare2 NULL, spare1 NULL
    },
```

| | |
|---|---|
| criticalExtensionsFuture | SEQUENCE { } |

}
}

| | |
|---|---|
| CG-Config-IEs ::= | SEQUENCE { |
| scg-CellGroupConfig | OCTET STRING (CONTAINING |

| | |
|---|---|
| RRCReconfiguration) | OPTIONAL, |

| | |
|---|---|
| scg-RB-Config | OCTET STRING (CONTAINING |

| | |
|---|---|
| RadioBearerConfig) | OPTIONAL, |

| | |
|---|---|
| configRestrictModReq | ConfigRestrictModReqSCG |

OPTIONAL,

| | |
|---|---|
| drx-InfoSCG | DRX-Info |

OPTIONAL,

| | |
|---|---|
| candidateCellInfoListSN | OCTET STRING |

| | |
|---|---|
| (CONTAINING MeasResultList2NR) | OPTIONAL, |

| | |
|---|---|
| measConfigSN | MeasConfigSN |

OPTIONAL,

| | |
|---|---|
| selectedBandCombination | BandCombinationInfoSN |

OPTIONAL,

| | |
|---|---|
| fr-InfoListSCG | FR-InfoList |

OPTIONAL,
candidateServingFreqListNR

| | |
|---|---|
| CandidateServingFreqListNR | OPTIONAL, |
| nonCriticalExtension | CG-Config-v1540-IEs |

OPTIONAL
}

| | |
|---|---|
| CG-Config-v1540-IEs ::= | SEQUENCE { |

| | |
|---|---|
| pSCellFrequency | ARFCN-ValueNR |

OPTIONAL,

| | |
|---|---|
| reportCGI-RequestNR | SEQUENCE { |
| requestedCellInfo | SEQUENCE { |
| ssbFrequency | ARFCN-ValueNR, |
| cellForWhichToReportCGI | PhysCellId |

```
    }
OPTIONAL
  }
OPTIONAL,
```

| | |
|---|---|
| ph-InfoSCG | PH-TypeListSCG |

OPTIONAL,

| | |
|---|---|
| nonCriticalExtension | CG-Config-v1560-IEs |

OPTIONAL
}

| | |
|---|---|
| CG-Config-v1560-IEs ::= | SEQUENCE { |

| | |
|---|---|
| pSCellFrequencyEUTRA | ARFCN-ValueEUTRA |

OPTIONAL,

| | |
|---|---|
| scg-CellGroupConfigEUTRA | OCTET STRING |

OPTIONAL,

| | |
|---|---|
| candidateCellInfoListSN-EUTRA | OCTET STRING |

OPTIONAL,
candidateServingFreqListEUTRA

| | |
|---|---|
| CandidateServingFreqListEUTRA | OPTIONAL, |
| needForGaps | ENUMERATED {true} |

OPTIONAL,

| | |
|---|---|
| drx-ConfigSCG | DRX-Config |

OPTIONAL,

| | |
|---|---|
| reportCGI-RequestEUTRA | SEQUENCE { |
| requestedCellInfoEUTRA | SEQUENCE { |

| | |
|---|---|
| eutraFrequency | ARFCN- |

ValueEUTRA,

| | |
|---|---|
| cellForWhichToReportCGI-EUTRA | EUTRA- |

```
PhysCellId
    }
OPTIONAL
  }
OPTIONAL,
```

| | |
|---|---|
| nonCriticalExtension | CG-Config-v1590-IEs |

OPTIONAL
}

| | |
|---|---|
| CG-Config-v1590-IEs ::= | SEQUENCE { |

| | |
|---|---|
| scellFrequenciesSN-NR | SEQUENCE (SIZE (1.. |

| | |
|---|---|
| maxNrofServingCells-1)) OF ARFCN-ValueNR | OPTIONAL, |

| | |
|---|---|
| scellFrequenciesSN-EUTRA | SEQUENCE (SIZE (1.. |

| | |
|---|---|
| maxNrofServingCells-1)) OF ARFCN-ValueEUTRA | OPTIONAL, |

| | |
|---|---|
| nonCriticalExtension | CG-Config-v1610-IEs |

OPTIONAL
}

| | |
|---|---|
| CG-Config-v1610-IEs ::= | SEQUENCE { |

| | |
|---|---|
| drx-InfoSCG2 | DRX-Info2 |

OPTIONAL,

| | |
|---|---|
| nonCriticalExtension | CG-Config-v1620-IEs |

OPTIONAL
}

| | |
|---|---|
| CG-Config-v1620-IEs ::= | SEQUENCE { |

| | |
|---|---|
| ueAssistanceInformationSCG-r16 | OCTET STRING |

(CONTAINING UEAssistanceInformation) OPTIONAL,

| | |
|---|---|
| nonCriticalExtension | CG-Config-v1630-IEs |

OPTIONAL
}

| | |
|---|---|
| CG-Config-v1630-IEs ::= | SEQUENCE { |

| | |
|---|---|
| selectedToffset-r16 | T-Offset-r16 |

OPTIONAL,

| | |
|---|---|
| nonCriticalExtension | CG-Config-v1640-IEs |

OPTIONAL
}

| | |
|---|---|
| CG-Config-v1640-IEs ::= | SEQUENCE { |

| | |
|---|---|
| servCellInfoListSCG-NR-r16 | ServCellInfoListSCG- |

| | |
|---|---|
| NR-r16 | OPTIONAL, |

| | |
|---|---|
| servCellInfoListSCG-EUTRA-r16 | ServCellInfoListSCG- |

| | |
|---|---|
| EUTRA-r16 | OPTIONAL, |

| | |
|---|---|
| nonCriticalExtension | CG-Config-v1700-IEs |

OPTIONAL
}

| | |
|---|---|
| CG-Config-v1700-IEs ::= | SEQUENCE { |

candidateCellInfoListCPC-r17

| | |
|---|---|
| CandidateCellInfoListCPC-r17 | OPTIONAL, |
| twoPHRModeSCG-r17 | ENUMERATED {enabled} |

OPTIONAL,

| | |
|---|---|
| nonCriticalExtension | SEQUENCE { } |

OPTIONAL
}

| | |
|---|---|
| CG-Config-v1800-IEs ::= | SEQUENCE { |

ranVisibleQoE-ConfigurationInformation-r18

| | |
|---|---|
| RanVisibleQoE-ConfigurationInformation | -r18 |

OPTIONAL,

| | |
|---|---|
| nonCriticalExtension | SEQUENCE { } |

OPTIONAL
}

| | |
|---|---|
| ServCellInfoListSCG-NR-r16 ::= | SEQUENCE (SIZE (1.. |

maxNrofServingCells)) OF ServCellInfoXCG-NR-r16

| | |
|---|---|
| ServCellInfoXCG-NR-r16 ::= | SEQUENCE { |

| | |
|---|---|
| dl-FreqInfo-NR-r16 | FrequencyConfig-NR- |

| | |
|---|---|
| r16 | OPTIONAL, |

| | |
|---|---|
| ul-FreqInfo-NR-r16 | FrequencyConfig-NR- |

| | |
|---|---|
| r16 | OPTIONAL, -- Cond FDD |

...
}

| | |
|---|---|
| FrequencyConfig-NR-r16 ::= | SEQUENCE { |

| | |
|---|---|
| freqBandIndicatorNR-r16 | FreqBandIndicatorNR, |
| carrierCenterFreq-NR-r16 | ARFCN-ValueNR, |

| | |
|---|---|
| carrierBandwidth-NR-r16 | INTEGER |

(1..maxNrofPhysicalResourceBlocks),

| | |
|---|---|
| subcarrierSpacing-NR-r16 | SubcarrierSpacing |

}

| | |
|---|---|
| ServCellInfoListSCG-EUTRA-r16 ::= | SEQUENCE (SIZE (1.. |

maxNrofServingCellsEUTRA)) OF ServCellInfoXCG-EUTRA-r16

| | |
|---|---|
| ServCellInfoXCG-EUTRA-r16 ::= | SEQUENCE { |

| | |
|---|---|
| dl-CarrierFreq-EUTRA-r16 | ARFCN-ValueEUTRA |

OPTIONAL,

| | |
|---|---|
| ul-CarrierFreq-EUTRA-r16 | ARFCN-ValueEUTRA |

OPTIONAL, -- Cond FDD
transmissionBandwidth-EUTRA-r16

| | |
|---|---|
| TransmissionBandwidth-EUTRA-r16 | OPTIONAL, |

...
}
TransmissionBandwidth-EUTRA-r16 ::= ENUMERATED {rb6, rb15,
rb25, rb50, rb75, rb100}

| | |
|---|---|
| PH-TypeListSCG ::= | SEQUENCE (SIZE |

(1..maxNrofServingCells)) OF PH-InfoSCG

| | |
|---|---|
| PH-InfoSCG ::= | SEQUENCE { |

| | |
|---|---|
| servCellIndex | ServCellIndex, |
| ph-Uplink | PH-UplinkCarrierSCG, |
| ph-SupplementaryUplink | PH-UplinkCarrierSCG |

```
OPTIONAL,
  ...,
  [[
```

| | |
|---|---|
| twoSRS-PUSCH-Repetition-r17 | ENUMERATED{enabled} |

OPTIONAL
]]
}

| | |
|---|---|
| PH-UplinkCarrierSCG ::= | SEQUENCE{ |

| | |
|---|---|
| ph-Type1or3 | ENUMERATED {type1, |

type3},
...
}

| | |
|---|---|
| MeasConfigSN ::= | SEQUENCE { |

| | |
|---|---|
| measuredFrequenciesSN | SEQUENCE (SIZE |

(1..maxMeasFreqsSN)) OF NR-FreqInfo OPTIONAL,
...
}

| | |
|---|---|
| NR-FreqInfo ::= | SEQUENCE { |

| | |
|---|---|
| measuredFrequency | ARFCN-ValueNR |

OPTIONAL,
...
}

| | |
|---|---|
| ConfigRestrictModReqSCG ::= | SEQUENCE { |

| | |
|---|---|
| requestedBC-MRDC | BandCombinationInfoSN |

OPTIONAL,

| | |
|---|---|
| requestedP-MaxFR1 | P-Max |

```
OPTIONAL,
  ...,
  [[
```

| | |
|---|---|
| requestedPDCCH-BlindDetectionSCG | INTEGER (1..15) |

OPTIONAL,

| | |
|---|---|
| requestedP-MaxEUTRA | P-Max |

```
OPTIONAL
  ]],
  [[
```

| | |
|---|---|
| requestedP-MaxFR2-r16 | P-Max |

OPTIONAL,
requestedMaxInterFreqMeasIdSCG-r16

| | |
|---|---|
| INTEGER(1..maxMeasIdentitiesMN) | OPTIONAL, |

requestedMaxIntraFreqMeasIdSCG-r16

| | |
|---|---|
| INTEGER(1..maxMeasIdentitiesMN) | OPTIONAL, |

| | |
|---|---|
| requestedToffset-r16 | T-Offset-r16 |

OPTIONAL
]]
}
BandCombinationIndex ::= INTEGER (1..maxBandComb)

| | |
|---|---|
| BandCombinationInfoSN ::= | SEQUENCE { |

| | |
|---|---|
| bandCombinationIndex | BandCombinationIndex, |
| requestedFeatureSets | FeatureSetEntryIndex |

}
FR-InfoList ::= SEQUENCE (SIZE (1..maxNrofServingCells-1)) OF
FR-Info
FR-Info ::= SEQUENCE {

| | |
|---|---|
| servCellIndex | ServCellIndex, |
| fr-Type | ENUMERATED {fr1, fr2} |

}
CandidateServingFreqListNR ::= SEQUENCE (SIZE (1..
maxFreqIDC-MRDC)) OF ARFCN-ValueNR
CandidateServingFreqListEUTRA ::= SEQUENCE (SIZE (1..
maxFreqIDC-MRDC)) OF ARFCN-ValueEUTRA
T-Offset-r16 ::= ENUMERATED {ms0dot5, ms0dot75, ms1, ms1dot5,
ms2, ms2dot5, ms3, spare1}
CandidateCellInfoListCPC-r17 ::= SEQUENCE (SIZE
(1..ffsUpperLimit)) OF CandidateCellInfo-r17 -- FFS

| | |
|---|---|
| CandidateCellInfo-r17 ::= | SEQUENCE { |
| ssbFrequency-r17 | ARFCN-ValueNR, |

| | |
|---|---|
| candidateList-r17 | SEQUENCE (SIZE |

(1..ffsUpperLimit)) OF CandidateCell-r17 -- FFS
}

| | |
|---|---|
| CandidateCell-r17 ::= | SEQUENCE { |
| physCellId-r17 | PhysCellId, |
| condExecutionCondSCG-r17 | OCTET STRING (CONTAINING |

| | |
|---|---|
| CondReconfigExecCondSCG-r17) | OPTIONAL |

-- FFS whether the Optional flag is to be removed from
condExecutionConditionSN-r17
}
RanVisibleQoE-ConfigurationInformation-r18 ::= SEQUENCE {

| | | |
|---|---|---|
| maxNrofAllowedQoEConfig | INTEGER (1..15) | OPTIONAL, |
| nrOfQoEConfigatMN | INTEGER (1..15) | OPTIONAL |

}
-- TAG-CG-CONFIG-STOP
-- ASN1STOP

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 9, the hub 914 communicates with the access network 904 to facilitate indirect communication between one or more UEs (e.g., UE 912c and/or 912d) and network nodes (e.g., network node 910b). In some examples, the hub 914 may be a controller, router, a content source and analytics node, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs). The processing circuitry 1002 may be operable to provide, either alone or in conjunction with other UE 1000 components, such as the memory 1010, UE 1000 functionality. For example, the processing circuitry 1002 may be configured to cause the UE 1002 to perform the methods as described with reference to FIG. 6.

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In some embodiments, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes processing circuitry 1102, a memory 1104, a communication interface 1106, and a power source 1108, and/or any other component, or any combination thereof. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, network node 1100 functionality. For example, the processing circuitry 1102 may be configured to cause the network node to perform the methods as described with reference to FIG. 7.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

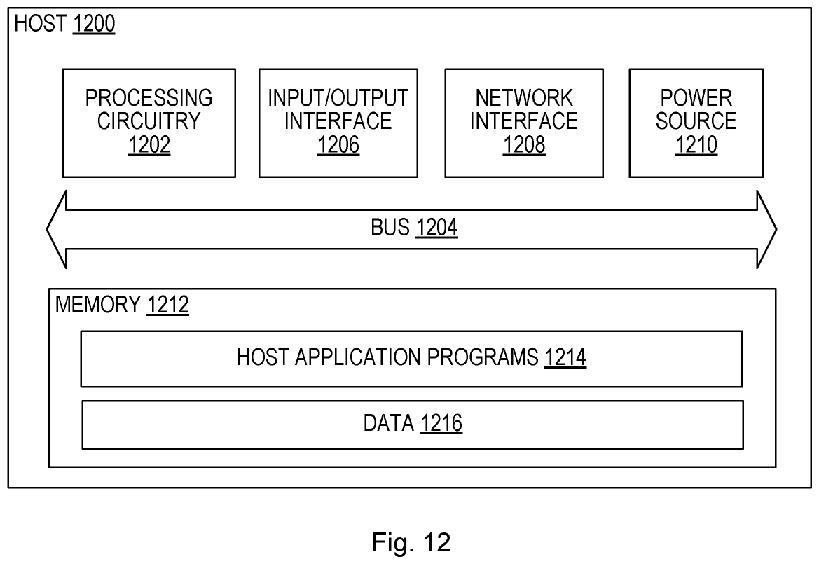

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

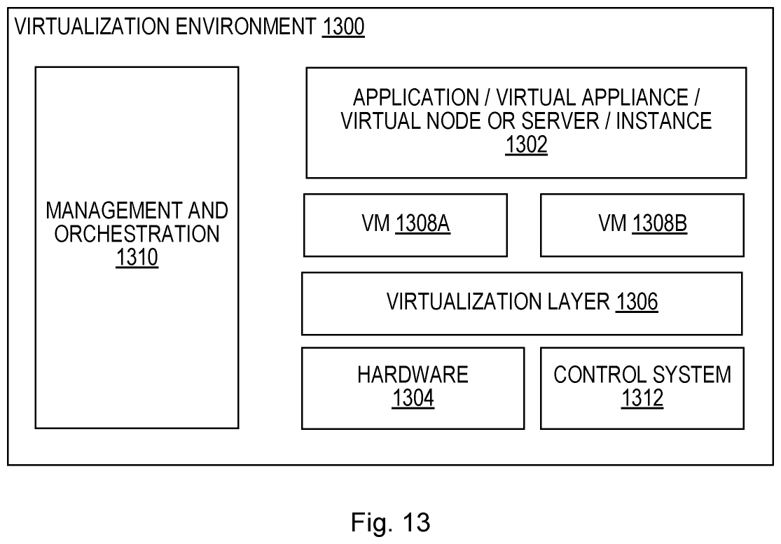

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

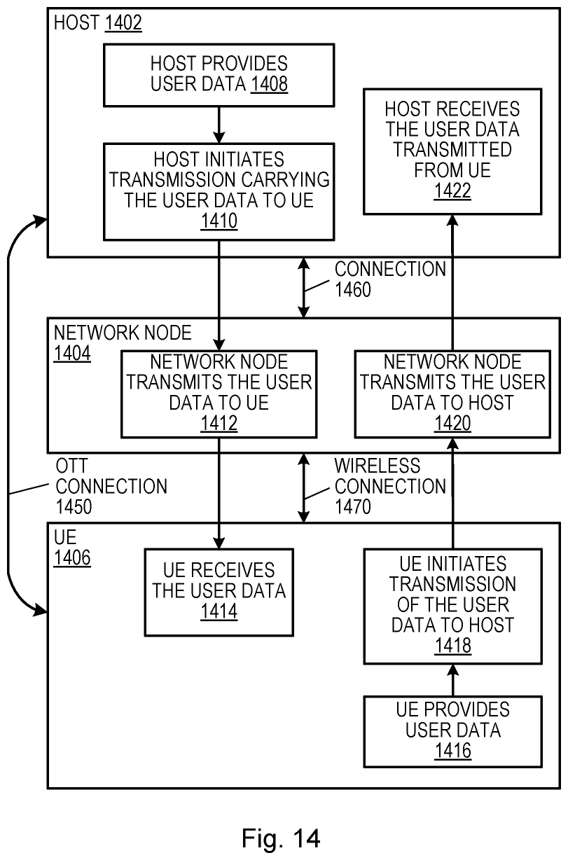

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The following numbered statements provide additional information on the disclosure:
1. A method performed by a user equipment, UE, the method comprising:
   receiving a first message comprising a first RAN-Visible Quality of Experience, RV-QoE configuration of a first network node;
   receiving a second message comprising a second RV-QoE configuration of a second network node;
   determining whether the first network node or the second network node is delivering data for a session; and
   using the RV-QoE configuration of the determined network node to make RV-QoE measurements.
2. The method of statement 1 further comprising:
   initiating RV-QoE measurements according to the RV-QoE configuration of the determined network node.
3. The method of any of the previous statements, further comprising:
   providing user data; and
   forwarding the user data to a host via the transmission to the network node.
4. A method performed by a first network node in a communications network, the method comprising:
   sending a first message comprising an indication of a first RAN-Visible Quality of Experience, RV-QoE configuration of the first network node, to a second network node, wherein the first message indicates to the second network node that the first network node has configured a User Equipment, UE, for RV-QoE measurements.
5. A method as in statement 4 wherein the step of sending the first message is performed as part of a procedure to add the second network node as a secondary network node in a multi-radio dual connectivity (MR-DC) procedure for the UE.
6. A method as in statement 4 or 5, the method comprising:
   sending a second message to the second network node to request that the second network node sends an indication of a second RV-QoE configuration of the second network node, to the first network node.
7. The method of statement 6 wherein, upon receiving the second RV-QoE configuration, the method further comprises:
   determining whether there is a conflict between the first RV-QoE configuration and the second RV-QoE configuration.
8. The method of statement 7 wherein it is determined that a conflict is present if:
   a first QoE configuration identifier in the first RV-QoE configuration is the same as a second QoE configuration identifier in the second RV-QoE configuration;
   a first reporting periodicity in the first RV-QoE configuration for a first service type is different to a second reporting periodicity in the second RV-QoE configuration for the first service type;
   a first reporting trigger in the first RV-QoE configuration for the first service type is different to a second reporting trigger in the second RV-QoE configuration for the first service type;
   a first requested reporting periodicity for a first RV-QoE metric in the first RV-QoE configuration is different to a second requested reporting periodicity for the first RV-QoE metric in the second RV-QoE configuration;
   reporting is periodic in the first RV-QoE configuration and initiated by a trigger in the second RV-QoE configuration;
   reporting periodicity is configured in the first RV-QoE configuration and not configured for the second RV-QoE configuration; and/or measurements are stored according to the first RV-QoE configuration and reported periodically in the second RV-QoE configuration.
9. The method of statement 6, 7 or 8 wherein, in response to determining that the first RV-QoE configuration and the second RV-QoE configuration have one or more configuration parameters in common, the method further comprises:
   determining an action to perform.
10. The method of statement 6, 7, 8 or 9 wherein, in response to determining a conflict between the first RV-QoE configuration and the second RV-QoE configuration, the method further comprises obtaining a resolved RV-QoE as a result of:
   discarding one of the first RV-QoE configuration and the second RV-QoE configuration;
   remove one or more third RV-QoE metrics or third RV-QoE values from the first RV-QoE configuration;
   remove one or more fourth RV-QoE metrics or fourth RV-QoE values from the second RV-QoE configuration;
   align the first requested reporting periodicity for a first RV-QoE metric in the first RV-QoE configuration and the second requested reporting periodicity for the first RV-QoE metric in the second RV-QoE configuration;
   if the conflict arises because in one of the first RV-QoE configuration and the second RV-QoE configuration, the reporting is periodic, while in the other of the first RV-QoE configuration and the second RV-QoE configuration, the reporting is event-triggered, selecting a new reporting mechanism to resolve the conflict; and if the conflict arises because in one of the first RV-QoE configuration and the second RV-QoE configuration, the reporting is not specified, using the one of the first RV-QoE configuration and the second RV-QoE configuration that does specify the reporting mechanism, in order to resolve the conflict.
11. The method of statement 10 further comprising:
   sending the resolved RV-QoE to the UE.
12. The method of statement 6, 7, 8, 9 or 10 wherein, in response to determining a conflict between the first RV-QoE configuration and the second RV-QoE configuration, the method further comprises:
   discarding RV-QoE reports associated with one of the first RV-QoE configuration and the second RV-QoE configuration.
13. The method of statement 6, 7, 8, 9, 10 or 12 further comprising:
   merging the first RV-QoE configuration and the second RV-QoE configuration to obtain a merged RV-QoE configuration; and
   sending a third message comprising the merged RV-QoE configuration to the UE.
14. The method of statement 6 to 13 further comprising:
   configuring the UE with the first RV-QoE configuration of the first network node, or part thereof; or
   configuring the UE with the second RV-QoE configuration of the second network node, or part thereof.
15. The method of any one of statement 6 to 14 further comprising:
   sending a fourth message to the second network node, the fourth message indicating whether a conflict has been detected between the first RV-QoE configuration and the second RV-QoE configuration; and/or
   one or more actions associated with, or modifications to, the second RV-QoE configuration that the first network node has made to the second RV-QoE configuration.
16. The method of any of statements 4 to 15 wherein the first network node is a master node (MN) in a multi-radio dual connectivity (MR-DC) procedure for the UE and the second network node is a secondary node in the MR-DC procedure.
17. The method of any of statements 4 to 16 wherein the second network node is a master node (MN) in a multi-radio dual connectivity (MR-DC) procedure for the UE and the first network node is a secondary node in the MR-DC procedure.
18. The method of any of statements 4 to 17, further comprising:
   obtaining user data; and
   forwarding the user data to a host or to the UE.
19. A method in a second network node, the method comprising:
   receiving a first message comprising an indication of a first RAN-Visible Quality of Experience, RV-QoE configuration of the first network node, to a second network node, wherein the first message indicates to the second network node that the first network node has configured a User Equipment, UE, for RV-QoE measurements.
20. A method as in statement 19 further comprising:
   receiving a second message requesting that the second network node sends an indication of a second RV-QoE configuration of the second network node, to the first network node; and
   sending the requested second RV-QoE configuration of the second network node, to the first network node.
21. A user equipment comprising:
   processing circuitry configured to cause the user equipment to perform any of the steps of any of statements 1 to 3; and
   power supply circuitry configured to supply power to the processing circuitry.
22. A first network node, the first network node comprising:
   processing circuitry configured to cause the network node to perform any of the steps of any of statements 4 to 18;
   power supply circuitry configured to supply power to the processing circuitry.
23. A second network node, the second network node comprising:
   processing circuitry configured to cause the network node to perform any of the steps of any of statements 19 or 20;
   power supply circuitry configured to supply power to the processing circuitry.
24. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of statements 1 to 3;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
25. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of statements 1 to 3 to receive the user data from the host.
26. The host of statement 25, wherein the cellular network further includes a network node configured to communicate with the UE to transmit the user data to the UE from the host.
27. The host of statement 24 or 25, wherein:
   the processing circuitry of the host is configured to execute a host application, thereby providing the user data; and
   the host application is configured to interact with a client application executing on the UE, the client application being associated with the host application.
28. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of statements 1 to 3 to receive the user data from the host.
29. The method of statement 28, further comprising:
   at the host, executing a host application associated with a client application executing on the UE to receive the user data from the UE.
30. The method of statement 29, further comprising:
   at the host, transmitting input data to the client application executing on the UE, the input data being provided by executing the host application, wherein the user data is provided by the client application in response to the input data from the host application.
31. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of statements 1 to 3 to transmit the user data to the host.
32. The host of statement 31, wherein the cellular network further includes a network node configured to communicate with the UE to transmit the user data from the UE to the host.
33. The host of statement 31 or 32, wherein:
   the processing circuitry of the host is configured to execute a host application, thereby providing the user data; and
   the host application is configured to interact with a client application executing on the UE, the client application being associated with the host application.
34. A method implemented by a host configured to operate in a communication system that further includes a network node and a user equipment (UE), the method comprising:
   at the host, receiving user data transmitted to the host via the network node by the UE, wherein the UE performs any of the steps of any of statements 1 to 3 to transmit the user data to the host.
35. The method of statement 34, further comprising:
   at the host, executing a host application associated with a client application executing on the UE to receive the user data from the UE.
36. The method of statement 35, further comprising:
   at the host, transmitting input data to the client application executing on the UE, the input data being provided by executing the host application,
   wherein the user data is provided by the client application in response to the input data from the host application.
37. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of statements 4 to 18 to transmit the user data from the host to the UE.
38. The host of statement 37, wherein:
   the processing circuitry of the host is configured to execute a host application that provides the user data; and
   the UE comprises processing circuitry configured to execute a client application associated with the host application to receive the transmission of user data from the host.
39. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of statements 4 to 18 to transmit the user data from the host to the UE.
40. The method of statement 39, further comprising, at the network node, transmitting the user data provided by the host for the UE.
41. The method of statement 39 or 40, wherein the user data is provided at the host by executing a host application that interacts with a client application executing on the UE, the client application being associated with the host application.
42. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any statements 4 to 18 to transmit the user data from the host to the UE.
43. The communication system of statement 42, further comprising:
   the network node; and/or
   the user equipment.
44. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of statements 4 to 18 to receive the user data from a user equipment (UE) for the host.
45. The host of statement 44, wherein:
   the processing circuitry of the host is configured to execute a host application, thereby providing the user data; and
   the host application is configured to interact with a client application executing on the UE, the client application being associated with the host application.
46. The host of the any of statements 44 or 45, wherein the initiating receipt of the user data comprises requesting the user data.
47. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of statements 4 to 18 to receive the user data from the UE for the host.
48. The method of statement 47, further comprising at the network node, transmitting the received user data to the host.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
3GPP 3rd Generation Partnership Project
5G 5th Generation
5GC 5G Core network
5GS 5th Generation System
AS Access Stratum
AMF Access and Mobility Management Function
ASN.1 Abstract Syntax Notation One
AT Attention
AR Augmented Reality
AS Access Stratum
BAP Backhaul Adaptation Protocol
CGI Cell Global Identity
CN Core Network
CP Control Plane
CU Central Unit
CU-CP Central Unit Control Plane
CU-UP Central Unit User Plane
DU Distributed Unit
DASH Dynamic Adaptive Streaming over HTTP
DC Dual Connectivity
DL Downlink
DNS Domain Name System
DU Distributed Unit
E-CGI E-UTRAN CGI
eNB Evolved Node B/E-UTRAN Node B
en-gNB A gNB acting as a secondary node in an EN-DC scenario (i.e. in a DC scenario with an eNB as the master node and a gNB as the secondary node.
EN E-UTRAN-NR
EPC Evolved Packet Core
EPS Evolved Packet System
E-UTRA Evolved UTRA
E-UTRAN/EUTRAN Evolved UTRAN
gNB Radio base station in NR
HSS Home Subscriber Server
HTTP Hypertext Transfer Protocol
IAB Integrated Access and Backhaul
ID Identifier/Identity
IE Information Element
LTE Long Term Evolution
MAC Medium Access Control
MCC Mobile Country Code
MCE Measurement Collection Entity/Measurement Collector Entity
MDT Minimization of Drive Tests
MME Mobility Management Entity
MN Master Node
MNC Mobile Network Code
MTSI Multimedia Telephony Service for IMS
N3IWF Non-3GPP Interworking Function
NG Next Generation
NG The interface between an NG-RAN and a 5GC.
NGAP NG Application Protocol
NG-RAN NG Radio Access Network
NID Network identifier
NR New Radio
NWDAF Network Data Analytics Function
O&M Operation and Maintenance
OAM Operation and Maintenance
PDCP Packet Data Convergence Protocol
PDU Protocol Data Unit
PLMN Public Land Mobile Network
QMC QoE Measurement Collection
QoE Quality of Experience
QoS Quality of Service
RAN Radio Access Network
RAT Radio Access Technology
RLC Radio Link Control
RNC Radio Network Controller
RRC Radio Resource Control
RVQOE RAN Visible QoE
S1 The interface between the RAN and the CN in LTE.
S1AP S1 Application Protocol
S-NSSAI Single Network Slice Selection Assistance Information
SMO Service Management and Orchestration
SN Secondary Node
SRB Signaling Radio Bearer
TA Tracking Area
TCE Trace Collection Entity/Trace Collector Entity
TNGF Trusted Non-3GPP Gateway Function
TWIF Trusted WLAN Interworking Function
UDM Unified Data Management
UE User Equipment
UMTS Universal Mobile Telecommunication System
URI Uniform Resource Identifier
URL Uniform Resource Locator Uniform Resource Locator
UTRA Universal Terrestrial Radio Access
UTRAN Universal Terrestrial Radio Access Network
VR Virtual Reality
WLAN Wireless Local Area Network
Xn The interface between two gNBs in NR.
XnAP Xn Application Protocol
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1-29. (canceled)

30. A method performed by a user equipment (UE) the method comprising:
receiving a first message comprising a first Radio Access Network-Visible Quality of Experience (RV-QoE) configuration of a first network node;
receiving a second message comprising a second RV-QoE configuration of a second network node;
determining whether the first network node or the second network node is delivering data for a session; and
using the RV-QoE configuration of the determined network node to make RV-QoE measurements.

31. The method of claim 30 further comprising:
initiating RV-QoE measurements according to the RV-QoE configuration of the determined network node.

32. A method performed by a first network node in a communications network, the method comprising:
sending a first message comprising an indication of a first Radio Access Network-Visible Quality of Experience (RV-QoE) configuration of the first network node, to a second network node, wherein the first message indicates to the second network node that the first network node has configured a User Equipment (UE) for RV-QoE measurements.

33. The method of claim 32, wherein the step of sending the first message is performed as part of a procedure to add the second network node as a secondary network node in a multi-radio dual connectivity (MR-DC) procedure for the UE.

34. The method of claim 32, the method comprising:
sending a second message to the second network node to request that the second network node sends an indication of a second RV-QoE configuration of the second network node, to the first network node.

35. The method of claim 34, wherein, upon receiving the second RV-QoE configuration, the method further comprises:
determining whether there is a conflict between the first RV-QoE configuration and the second RV-QoE configuration.

36. The method of claim 35, wherein it is determined that a conflict is present if:
a first QoE configuration identifier in the first RV-QoE configuration is the same as a second QoE configuration identifier in the second RV-QoE configuration;
a first reporting periodicity in the first RV-QoE configuration for a first service type is different to a second reporting periodicity in the second RV-QoE configuration for the first service type;
a first reporting trigger in the first RV-QoE configuration for the first service type is different to a second reporting trigger in the second RV-QoE configuration for the first service type;
a first requested reporting periodicity for a first RV-QoE metric in the first RV-QoE configuration is different to a second requested reporting periodicity for the first RV-QoE metric in the second RV-QoE configuration;
reporting is periodic in the first RV-QoE configuration and initiated by a trigger in the second RV-QoE configuration;
reporting periodicity is configured in the first RV-QoE configuration and not configured for the second RV-QoE configuration; and/or
measurements are stored according to the first RV-QoE configuration and reported periodically in the second RV-QoE configuration.

37. The method of claim 34, wherein, in response to determining that the first RV-QoE configuration and the second RV-QoE configuration have one or more configuration parameters in common, the method further comprises:
determining an action to perform.

38. The method of claim 34, wherein, in response to determining a conflict between the first RV-QoE configuration and the second RV-QoE configuration, the method further comprises obtaining a resolved RV-QoE as a result of:
discarding one of the first RV-QoE configuration and the second RV-QoE configuration;
remove one or more third RV-QoE metrics or third RV-QoE values from the first RV-QoE configuration;
remove one or more fourth RV-QoE metrics or fourth RV-QoE values from the second RV-QoE configuration;
align the first requested reporting periodicity for a first RV-QoE metric in the first RV-QoE configuration and the second requested reporting periodicity for the first RV-QoE metric in the second RV-QoE configuration;
if the conflict arises because in one of the first RV-QoE configuration and the second RV-QoE configuration, the reporting is periodic, while in the other of the first RV-QoE configuration and the second RV-QoE configuration, the reporting is event-triggered, selecting a new reporting mechanism to resolve the conflict; and
if the conflict arises because in one of the first RV-QoE configuration and the second RV-QoE configuration, the reporting is not specified, using the one of the first RV-QoE configuration and the second RV-QoE configuration that does specify the reporting mechanism, in order to resolve the conflict.

39. The method of claim 38 further comprising:
sending the resolved RV-QoE configuration to the UE.

40. The method of claim 34, wherein, in response to determining a conflict between the first RV-QoE configuration and the second RV-QoE configuration, the method further comprises:
discarding RV-QoE reports associated with one of the first RV-QoE configuration and the second RV-QoE configuration.

41. The method of claim 34, further comprising:
merging the first RV-QoE configuration and the second RV-QoE configuration to obtain a merged RV-QoE configuration; and
sending a third message comprising the merged RV-QoE configuration to the UE.

42. The method of claim 34 further comprising:
configuring the UE with the first RV-QoE configuration of the first network node, or part thereof; or
configuring the UE with the second RV-QoE configuration of the second network node, or part thereof.

43. The method of claim 34 further comprising:
sending a fourth message to the second network node, the fourth message indicating whether a conflict has been detected between the first RV-QoE configuration and the second RV-QoE configuration; and/or
one or more actions associated with, or modifications to, the second RV-QoE configuration that the first network node has made to the second RV-QoE configuration.

44. The method of claim 32, wherein the first network node is a master node (MN) in a multi-radio dual connectivity (MR-DC) procedure for the UE and the second network node is a secondary node in the MR-DC procedure.

45. The method of claim 32, wherein the second network node is a master node (MN) in a multi-radio dual connectivity (MR-DC) procedure for the UE and the first network node is a secondary node in the MR-DC procedure.

46. A method in a second network node, the method comprising:
receiving a first message comprising an indication of a first RAN-Visible Quality of Experience (RV-QoE) configuration of the first network node, to a second network node, wherein the first message indicates to the second network node that the first network node has configured a User Equipment (UE) for RV-QoE measurements.

47. The method of claim 46, further comprising:
receiving a second message requesting that the second network node sends an indication of a second RV-QoE configuration of the second network node, to the first network node; and
sending the requested second RV-QoE configuration of the second network node, to the first network node.

48. A user equipment comprising:
processing circuitry, and
memory coupled to the processing circuitry, wherein the memory includes instructions that when executed by the processing circuitry cause the user equipment to perform the steps of:
receiving a first message comprising a first Radio Access Network-Visible Quality of Experience (RV-QoE) configuration of a first network node;
receiving a second message comprising a second RV-QoE configuration of a second network node;
determining whether the first network node or the second network node is delivering data for a session; and
using the RV-QoE configuration of the determined network node to make RV-QoE measurements.

49. The user equipment of claim 48, wherein the instructions are further configured to cause the user equipment to initiate RV-QoE measurements according to the RV-QoE configuration of the determined network node.

50. A first network node, the first network node comprising:
processing circuitry, and
memory coupled to the processing circuitry, wherein the memory includes instructions that when executed by the processing circuitry cause the first network node to perform the step of:
sending a first message comprising an indication of a first Radio Access Network-Visible Quality of Experience (RV-QoE) configuration of the first network node, to a second network node, wherein the first message indicates to the second network node that the first network node has configured a User Equipment (UE) for RV-QoE measurements.

51. The first network node of claim 50, wherein the instructions are further configured to cause the first network node to perform the sending of the first message as part of a procedure to add the second network node as a secondary network node in a multi-radio dual connectivity (MR-DC) procedure for the UE.

52. A second network node, the second network node comprising:
processing circuitry, and
memory coupled to the processing circuitry, wherein the memory includes instructions that when executed by the processing circuitry cause the second network node to perform the step of:
receiving a first message comprising an indication of a first Radio Access Network-Visible Quality of Experience (RV-QoE) configuration of the first network node, to a second network node, wherein the first message indicates to the second network node that the first network node has configured a User Equipment (UE) for RV-QoE measurements.

53. The second network node of claim 52, wherein the instructions are further configured to cause the second network node to:
receive a second message requesting that the second network node sends an indication of a second RV-QoE configuration of the second network node, to the first network node; and
send the requested second RV-QoE configuration of the second network node, to the first network node.

54. A communication system comprising:
a user equipment (UE) comprising UE processing circuitry and UE memory coupled to the UE processing circuitry, wherein the UE memory includes instructions that when executed by the UE processing circuitry cause the UE to perform the steps of
receiving a first message comprising a first Radio Access Network-Visible Quality of Experience (RV-QoE) configuration of a first network node,
receiving a second message comprising a second RV-QoE configuration of a second network node,
determining whether the first network node or the second network node is delivering data for a session, and
using the RV-QoE configuration of the determined network node to make RV-QoE measurements;
the first network node, wherein the first network node comprises first network node processing circuitry and first network node memory coupled to the first network node processing circuitry, wherein the first network node memory includes instructions that when executed by the first network node processing circuitry cause the first network node to send a first message comprising an indication of a first Radio Access Network-Visible Quality of Experience (RV-QoE) configuration of the first network node, to a second network node, wherein the first message indicates to the second network node that the first network node has configured a User Equipment (UE) for RV-QoE measurements;
the second network node of claim 52.
